(19) United States
(12) Patent Application Publication
(10) Pub. No.: US 2016/0009402 A1
(43) Pub. Date: Jan. 14, 2016

(54) SOLAR RELAY AIRCRAFT POWERED BY GROUND BASED SOLAR CONCENTRATOR MIRRORS IN DUAL USE WITH POWER TOWERS

(71) Applicant: John William Hunter, Escondido, CA (US)

(72) Inventor: John William Hunter, Escondido, CA (US)

(21) Appl. No.: 14/155,360

(22) Filed: Jan. 15, 2014

(51) Int. Cl. B64D 27/24; B64C 39/02

(52) U.S. Cl. CPC B64D 27/24; B64C 39/02; B64C 2201/066; B64C 2201/042

(57) ABSTRACT

A solar relay aircraft system includes a solar relay aircraft having an upper surface, and a lower surface, and equipped with a solar radiation receiver on said lower surface and capable of converting solar energy to electrical energy. An electric motor in electrical connection with said solar radiation receiver to receive the electrical energy and drives a propeller to propel the solar relay aircraft. A number of ground-based reflector arrays include a plurality of reflecting mirrors for receiving solar radiation from the sun and direct the solar radiation from the sun towards the solar relay aircraft.

### RELATED APPLICATIONS

This application is a continuation-in-part and claims the benefit of priority to U.S. patent application Ser. No. 16/727,858, filed Aug. 29, 2013 entitled “Solar Relay Aircraft Powered By Ground Based Solar Concentrator Mirrors In Dual Use with Power Towers,” and currently co-pending, which in turn claims benefit of priority to U.S. Provisional Patent Application Ser. No. 61/743,227, filed Aug. 29, 2012 entitled “Solar Relay Aircraft Powered By Ground Based Solar Concentrator Mirrors In Dual Use with Power Towers”, and U.S. Provisional Patent Application Ser. No. 61/859,728, filed Jul. 29, 2013 entitled Solar Relay Aircraft Powered By Ground Based Mirrors in Dual Use with Power Towers.” Each application referenced above is hereby fully incorporated herein by this reference.

### FIELD OF THE INVENTION

This invention relates generally to the direction and use of solar energy power. This invention is more particularly, though not exclusively, useful as a solar collector system for providing concentrated solar energy to solar powered aircraft, and for directing solar energy to power towers which generate electricity for distribution on an energy grid.

### BACKGROUND OF THE INVENTION

With over 87,000 flights per day, airplanes have become a major mode of transportation for goods and people. Despite the utility of the modern day airplanes, these airplanes have their limitations. Conventional airplanes are powered with combustible fuels which are heavy, expensive, polluting, and are used-up quickly. The weight of the airplane with the additional weight of the fuel is heavy and thus requires a substantial amount of energy to operate. This limits the payload as well the operating time of an aircraft. Additionally, the large amounts of fuel used create excessive pollutants. Given the rising cost of fuel, conventional airplanes operate with large expenses per flight hour. As a result, solar/electric powered aircraft have been introduced to address the limitations of combustible fuel airplanes.

Using solar energy solves some of the major limitations of conventional combustible fueled aircraft. Solar energy is unlimited, is readily available during daylight hours, does not need to be stored, has a zero net effect on the environment, and is free and therefore not susceptible to price fluctuations. Working models have demonstrated the feasibility and utility of solar powered aircraft. However, current solar powered aircraft do not provide the same utility as combustible fueled aircraft. One primary reason for this deficiency is that current solar powered aircraft receive their energy directly from the sun through upper surface mounted solar cells, and thus operate at a single-sun solar power level.

Many solar powered aircraft rely on photovoltaic cells to convert solar energy into electricity to power an electric motor based propulsion system. Weather patterns affect the amount of solar energy available to photovoltaic cells. As a result, batteries or other types of energy storage systems are installed onboard the aircraft to store electrical energy and keep the aircraft aloft in circumstances where the photovoltaic cells may not provide enough electricity.

However, energy storage systems such as the battery impose a substantial weight burden on an aircraft that relies solely on solar power to operate. Furthermore, current photovoltaic/electric propulsion systems have a relatively small power to weight ratio, limiting the total weight a solar/electric aircraft can be. The tactic of adding additional surface area in which to mount photovoltaic cells beyond the minimum needed for the aircraft to fly or to add additional batteries rapidly reaches a point of diminishing returns. Moreover, current battery technology provides for an energy density is that is inadequate to propel the aircraft a long distance through the air, while maintaining altitude.

In light of the above, it would be advantageous to provide an aircraft powered by solar energy with the ability to produce higher thrust than conventional solar powered aircraft to enable it to move at higher speeds and carry higher payloads. It would further be advantageous to provide a solar powered aircraft with the ability to intercept and receive solar rays at concentrations between 1 and 100 suns or more, from below the aircraft, at angles between 10 to 90 degrees (with respect to horizontal), minimizing the need to directly face the sun. It would also be advantageous to provide a means capable of delivering concentrated solar power, such as solar power at multiple-sun intensities, to an aircraft at various angles flying along a path and to alternatively deliver concentrated solar power to stationary solar panels or blackened heat sinks for turbine or piston engine generators to energize the grid when not directed towards solar aircraft. It would further be advantageous to provide a means of delivering concentrated solar energy that is cheap to construct and cost-effective.

As a solar powered aircraft, it would operate with minimal noise and pollutants. It would further be advantageous to provide a solar powered aircraft having a high enough lift to drag ratio to reduce the power requirements of the aircraft. It would further be advantageous to provide a solar powered aircraft utilizing high efficiency motors to maximize the amount of available power.

### SUMMARY OF THE INVENTION

The present invention includes a transportation system having a solar powered aircraft, a means of using concentrated solar power directed from ground based mirrors to power solar powered aircraft at useful speeds along a path, and a control system to direct a reflected solar power beam toward passing solar powered aircraft and alternatively, to a solar energy collector. This system allows for the solar powered delivery of commuters and goods between locations, transmission and reception of high bandwidth communication, as well as surveillance and reconnaissance. The aircraft of the present invention nominally do not consume any hydrocarbon fuel nor do they emit any carbon dioxide. The aircraft of the present invention has the hybrid option of operating with on-board internal combustion engines to back up the electric engines in the event of a cloudy day or additional power is required, and to comply with the current FAA rules which require enough onboard fuel to fly at least 45 minutes beyond the aircraft's backup landing site.

The present invention further includes solar concentrators which can focus on a power tower equipped with either photovoltaic or turbine based receivers to produce power for the grid or alternatively as a heat source during periods when the mirrors are not used to direct solar power to the solar powered aircraft.

Historically solar powered airplanes have utilized solar cells, or photovoltaics, only on the top side of the aircraft wing to power the aircraft during the day. Due to the low intensity of un-concentrated sunlight, these aircraft have been somewhat fragile and slow. The present invention beams sunlight ranging from 1 sun (1,000 Watts/m²) up to concentrations of more than 100 suns (100,000 Watts/m²) onto solar cells on the underside of the aircraft. The solar cells of the present invention operate at efficiencies as high as 44% and generate electricity which powers electric motors and propel the aircraft. Currently the record solar cell is efficiency is 44% and is anticipated to be near 50% by 2020. The use of ground based concentrators plus high efficiency cells enables much higher power and thrust levels and hence higher performance and more robust aircraft than has been the case in the past.

The Solar Relay Aircraft (SRA), in a preferred embodiment, uses an elongated Blended Wing Body (BWB) which is a lifting body aircraft with wings and solar cells on the underside. The elongated/elliptical shape is to allow intercept of reflected sunlight from shallow angles coming from distant mirrors along the path. A blended wing shape exhibits additional benefits including lower drag and higher lift to drag than standard tube and wing aircraft shapes. The solar collectors on the underside of the aircraft are cooled by a liquid cooling array adjacent the collectors which flows through a heat exchanger, with the air flow on the bottom surface of the aircraft providing additional cooling capacity to the solar collectors and thereby maintaining their high efficiency. High energy density lithium ion batteries may provide additional power during takeoff and landing and excursions when there is no solar power available. In an alternative embodiment, the hybrid engine configuration can also be used for takeoff, landings or additional power requirements.

A heliostat, or mirror, facility contains several hundred heliostats. A heliostat (from helios, the Greek word for sun, and stat, as in stationary) is a device that includes a mirror, usually a plane mirror, which turns in both azimuth and elevation so as to keep reflecting sunlight toward a predetermined target, compensating for the sun's apparent motions in the sky. The target may be a physical object, distant from the heliostat, or a direction in space. To do this, the reflective surface of the mirror is kept perpendicular to the bisector of the angle between the directions of the sun and the target as seen from the mirror. In almost every case, the target is somewhat stationary relative to the distance from the aircraft to the heliostat, so the light is reflected in a nearly fixed direction.

In a preferred embodiment, the heliostat fields may be separated by as much as 2 km which may provide a 20% ripple of peak solar energy intensity at the aircraft. In this event the number of heliostat fields focusing on the aircraft at any point during its flight can be as few as 3 or 5. These 3 or 5 heliostat facilities form a module. This spacing is easy to employ since it means much fewer facilities, and hence fewer land use permits, are required. In an alternative application of the present invention, the SRA flies at 1 km altitude above the facilities, and there are nine (9) Heliostat Facilities focusing at one SRA at any point during its flight. These are typically located 500 meters apart and hence comprise a 4 km span. The Concentrator Mirror Array (CMA) is comprised of all the facilities along the route.

In a preferred embodiment, the solar Concentrator Mirror Array (CMA) of the present invention is dual use. The CMA provides intense solar power to the aircraft and also energizes solar Power Towers at each facility to provide power to the grid. Only those mirrors within a several km range will illuminate the aircraft. This is due to the solar divergence angle of ½ a degree. After the aircraft has passed out of range, the initial facilities and mirrors can return their focus to their respective nearby ground based Power Towers while downrange facilities and mirrors begin to illuminate the aircraft. In this way facilities and mirrors continuously illuminate the underside of the aircraft at typical intensities of 10 to 100 suns during its entire flight.

At any time the majority of facilities have the option of also providing grid power. The CMA includes a number of Mirror Modules which are themselves comprised of Mirror Facilities. A Mirror Module is comprised of all those Mirror Facilities which are beaming power to the SRA at a given time. Typically a Mirror Module will include all Mirror Facilities within several kilometers of the SRA as it flies overhead. Each Mirror Facility is a fenced enclosure which contains rows of individual mirrors. Herein, the System is referred to as the totality of SRAs and Power Towers powered by Mirror Facilities.

The CMA is configurable to be used in areas of moderate to high solar insolation, such as between Las Vegas and Los Angeles in the USA or between Alice Springs and Adelaide in Australia. Major benefits include the following: rapid and affordable solar powered aircraft transportation with substantial payloads; little or zero hydrocarbon fuel usage and commensurately near zero carbon dioxide emissions; renewable, zero emission and comparatively affordable grid electric power generated at those same locations.

The present invention includes three primary components, namely the Solar Relay Aircraft (SRA), the Concentrator Mirror Array (CMA) and the Power Towers. There are many advantages to the present invention, including but not limited to:

The SRAs in conjunction with the CMA provides useful transportation with minimal or zero use of hydrocarbon fuels. This reduces the dependence on oil as well as reducing carbon dioxide emissions. In addition, since there is minimal to zero exhaust and the expected noise levels to be reduced in comparison with conventional aircraft, the present invention may be used in closer proximity to populated areas.

The SRAs are more capable than conventional one-sun powered aircraft due to their ability to have much higher power densities at the solar cells. This enables heavier payloads and significantly shorter flight times.

The SRA's elongated elliptically shaped blended wing allows effective intercept of solar rays from the CMA at angles between 10 to 90 degrees from horizontal.

The SRA's primary cooling will be from a liquid coolant flowing in 2 mm channels behind the solar cells, circulated through an air cooled radiator, and with air flow over the lower surface of the wing to help maintain their efficiency. This is more robust than relying on convective heat transfer to the free stream air boundary layer. It also allows the use of low drag laminar airfoil shapes for the SRA since laminar skin drag is low with laminar heat transfer.

The SRA's blended wing offers a potentially high lift to drag ratio of over 20 as compared to conventional airplane shapes having lift to drag ratios between 10 and 20. This reduces power requirements since power is proportional to drag over lift.

The SRA's electric motor can be over 90% efficient compared to internal combustion engines which are below 40%. The electric motor may also be light weight.

The SRA can be powered with ducted fans or conventional propellers. These typically have efficiencies in excess of 80%.

The SRA's battery can be relatively light weight since it is only used for a few minutes at a time during takeoff and landing as well as possibly load leveling as the aircraft passes between heliostat fields.

The SRAs hybrid internal combustion engines/electric engines will allow the SRA to overcome temporary inclement weather and clouds or gaps in the heliostat facilities. The CMA mirrors and heliostats can be easily maintained with periodic washings.

In a simplified embodiment of the present invention, the CMA mirrors can have only one axis of rotation which reduces cost compared to heliostats with two axes. Heliostats typically cost between $100 and $200 per square meter partly due to the second axis. It is expected that the single axis mirrors will cost $100 per square meter or less due to its simple construction. Single axis mirrors will project a straight path of illumination at a given altitude for a SRA to follow. Modern Differential GPS plus other sensors will comprise an accurate Guidance Navigation and Control (GNC), allowing for flight accuracy so that the aircraft stays within the dynamic range of the beam of concentrated sunlight coming from below. A curved flight path can be accommodated by a discontinuous number of Mirror Facilities along straight paths on the ground, or, the SRA can rely on battery power for the short amount of time needed to adjust the flight path between Mirror Facilities.

The CMA will deliver concentrated sunlight at a much lower cost than microwaves or lasers. Conventional power beaming using lasers or microwaves is much more expensive than concentrated sunlight especially when the beam forming is included. As long as the SRA has a size commensurate to the reflected solar disc at that range the present invention can be much more cost effective than conventional power beaming. The reflected solar disc diameter is about 1% of the range so for example an SRA diameter of about 1%*1,000 meters=10 meters or more is necessary if the range is 1,000 meters.

The CMA mirrors will deliver concentrated sunlight to a solar image using inexpensive flat mirror segments, with the total image being elliptical or other round shapes comprised of many round solar images from the individual mirrors. Alternatively, the curvature of the mirror may be adjusted to create various focal lengths.

The Power Towers have the benefit of using all the surplus solar power to energize the grid. Since the CMA is providing dual use solar photons to the Power Towers, a simple receiver can supply electricity to the grid at affordable cost.

Another use of the solar relay aircraft of the present invention includes an environment equipped with a number of mirror facilities which can direct solar energy onto one or more SRA flying locally, such as flying in a defined pattern adjacent the mirror facility, or between various mirror facilities in a region. The SRA of the present invention may be equipped with instrumentation only, without the added weight of human cargo, and controlled remotely, to further decrease the weight of the SRA. This version of the SRA can include a larger battery system capable of being recharged during daylight periods, and store sufficient charge to power the SRA throughout the night without having to use any hydrocarbon fuels, or land and recharge. For instance, the SRA of the present invention may be used as an unmanned aircraft capable of operation 24 hours a day for an indefinite period by flying over a mirror facility long enough to recharge the batteries. The weight of an instrument-only SRA would be low enough that a high intensity reflected solar energy beam would be sufficient to provide the SRA with sufficient energy to power the propulsion system even during periods of darkness.

### BRIEF DESCRIPTION OF THE FIGURES

The nature, objects, and advantages of the present invention will become more apparent to those skilled in the art after considering the following detailed description in connection with the accompanying drawings, in which like reference numerals designate like parts throughout, and wherein:

FIGS. 1 and 2 are top and bottom perspective views of a preferred embodiment of the solar relay aircraft of the present invention having an array of solar collectors on its underside, a pair of electric motors and internal combustion engines which drive a pair of propellers, and having an enlarged passenger compartment and an array of electronic equipment for surveillance and monitoring;

FIG. 3 is a top perspective view of the solar relay aircraft of FIGS. 1 and 2 and shows the passenger compartment and the inlet and exhaust ports for the internal combustion engines;

FIG. 4 is another top perspective view of the solar relay aircraft of FIG. 3 showing the dual propulsion systems, and the overall shape of the blended wing body;

FIG. 5 is an enlarged view of the dual propulsion systems showing the electric motors and internal combustion engines which can each drive a propeller and showing the battery compartments and central fuel tank, and the propeller blade detail;

FIG. 6 is an exemplary embodiment of the mirror facility of the present invention showing a number of solar relay mirrors capable of directing solar radiation towards either a solar relay aircraft to power the aircraft, or a local solar power tower to provide electrical power to the energy grid;

FIG. 7 is an enlarged view of the solar power tower within a mirror facility to receive the directed solar radiation for conversion to energy, and the associated cooling and inverter systems;

FIG. 8 is a system level drawing showing a solar relay aircraft of the present invention flying over a mirror facility and receiving solar radiation from multiple solar relay mirrors, and showing the local solar power tower;

FIG. 9 is a front perspective view of a preferred embodiment of the solar relay mirror of the present invention, having a substantially planar mirror surface positioned on a rigid frame which is coupled to a heliostat assembly allowing rotation of elevation and azimuth to direct the solar energy as desired towards either a solar relay aircraft or a solar power tower;

FIG. 10 is a back perspective view of the preferred embodiment of the solar relay mirror of the present invention, showing the substantially planar mirror surface positioned on the rigid frame, and the post-mounted heliostat assembly that allows for the selective rotation of elevation and azimuth;

FIG. 11 is an alternative back perspective view of the preferred embodiment of the solar relay mirror of the present invention, showing the substantially planar mirror surface nearly vertical to direct the solar energy as desired towards either a solar relay aircraft or a solar power tower, and in a position to facilitate cleaning as necessary;

FIG. 12 is a side view of an alternative preferred embodiment of the solar relay mirror of the present invention having a rigid frame coupled to a heliostat and having a mirror surface with linear actuators that can provide an adjustable radius of curvature to vary the focal length of the mirror and the divergence of the reflected solar energy;

FIG. 13 is a back perspective view of the alternative preferred embodiment of the solar relay mirror shown in FIG. 12, and showing the a rigid frame coupled to the heliostat with the mirror surface supported with linear actuators to provide an adjustable radius of curvature to the mirror;

FIG. 14 is a detailed perspective view of the alternative preferred embodiment of the solar relay mirror of FIGS. 12 and 13, showing the linear actuators that can provide an adjustable radius of curvature to vary the focal length of the reflected solar energy;

FIG. 15 is a block diagram of the system of the mirror facility control system showing the RF transceiver, GPS receiver, radar and optical tracking components, mirror radius, elevation and azimuth drives, and the power tower receiver and inverter;

FIG. 16 is a block diagram of the solar relay aircraft control system showing the RF transceiver, GPS receiver, navigational data and gyroscope inertial navigation system, the solar collector array with a number of solar cells equipped with a temperatures sensor and cooling system, and interfacing with the engine, battery and motor;

FIG. 17 is a top perspective view of an alternative embodiment of the solar relay aircraft of the present invention having a central fuselage with a passenger compartment, a pair of sealable battery compartments, a pair of electric motors mounted to the upper surface of the fuselage, and a pair of low wings extending from the bottom of the fuselage;

FIG. 18 is a bottom view of the alternative embodiment of the solar relay aircraft of FIG. 17, showing the slightly swept wings and lower surface of the fuselage equipped with an array of solar collectors;

FIG. 19 is a top perspective view of the alternative embodiment of the solar relay aircraft of FIGS. 17 and 18 showing a more detailed view of the passenger compartment, battery regulators and battery system;

FIG. 20 is a perspective view of an alternative embodiment of a mirror facility of the present invention showing a secured area having a number of single axis solar relay mirrors spaced apart to provide vehicle access, and to direct solar energy upwards towards a solar relay aircraft or power tower;

FIG. 21 is a top view of the alternative embodiment of the mirror facility of FIG. 20, and showing an array of mirrors separated for vehicle access and to ensure proper directional movement, secured with perimeter fencing, and showing an exemplary overhead solar relay aircraft;

FIG. 22 is a perspective view of the alternative embodiment of the mirror facility of FIGS. 20 and 21, and equipped with a movable power tower for receiving solar radiation for conversion to useful energy while not being directed towards a solar relay aircraft;

FIG. 23 is an exemplary perspective view of the solar relay aircraft of the present invention receiving solar power from a number of mirror facilities from directing sunlight towards the aircraft;

FIG. 24 is perspective view of an alternative embodiment of the system of the present invention showing a number of mirror facilities, and servicing a variety of solar relay aircraft simultaneously passing overhead on different flight paths, and showing local power towers to receive directed solar energy when the solar relay mirror is not directing solar energy towards a solar relay aircraft;

FIG. 25 is a is perspective view of an alternative embodiment of the system of the present invention showing a number of mirror facilities servicing a variety of solar relay aircraft each having differing flight paths, with some simultaneously passing overhead on different flight paths, some flying circular recharging flight paths, and others flying reconnaissance and receiving reflected solar energy from one of many different mirror facilities;

FIG. 26 is a table of an exemplary commuter aircraft of the present invention;

FIG. 27 is a table of an exemplary mirror facility of the present invention;

FIG. 28 is a table of an exemplary tower cost and performance of the present invention;

FIG. 29 is a table with the economics of the present invention with and without electricity sales; and

FIG. 30 is a graph depicting the nominal sunlight concentration on the solar relay aircraft identifying the “surfing” zone for the solar radiation energy.

### DETAILED DESCRIPTION OF THE INVENTION

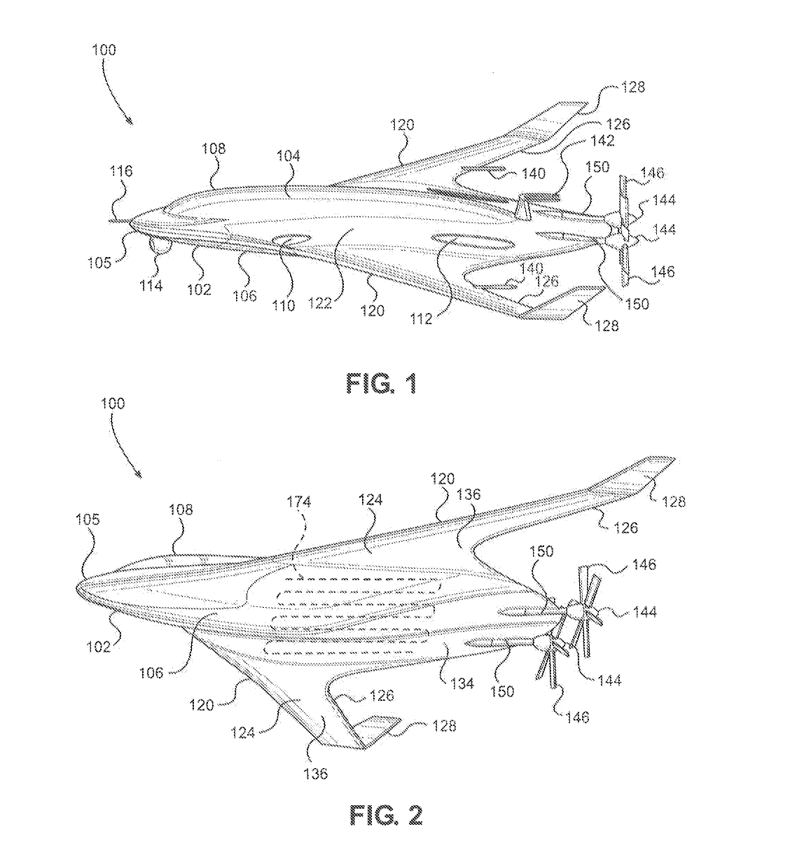

Referring now to FIG. 1, a top perspective view of a preferred embodiment of the solar relay aircraft (“SRA”) of the present invention is shown and generally designated 100. The SRA 100 uses an elongated Blended Wing Body (BWB) which is a lifting body aircraft with wings 120 blended to a body 102. The body 102 has a shape of an elongated disc, with the elongation in the direction of the flight path, having an upper surface 104 and a lower surface 106. At the front of the body 102 is a nose 105, further elongating the shape of body 102. Each wing 120 is located on either side of the body 102 and extends horizontally outwards. At the end of each wing 120, having an upper surface 122 and a lower surface 124, vertical stabilizers 128 are attached, pointing substantially vertical to improve stability of the SRA 100 while in flight. Attached to the wings 120 are antennas 140. A transponder 116 is attached to the nose 105 at the furthermost tip.

The upper surface 104 of body 102 includes a canopy 108, two air inlets 110, two air exhausts 112, and antenna 142. The canopy 108 is attached to the body 102 and blended to create smooth transition angles to reduce drag. The antenna 142 is attached to the upper surface 104 and protrudes vertically upwards. The air inlet 110, which directs air through a duct within the body 102 and corresponding air exhaust 112, which directs the air out, is located at the junction between the wing 120 and body 102. A pair of drive motors 150 is attached towards the rear of body 102. Each drive motor 150 has a propeller 144 formed with blades 146 attached. The propulsion of the SRA 100 is achieved by the drive motors 150 rotating propeller 144 formed with blades 146.

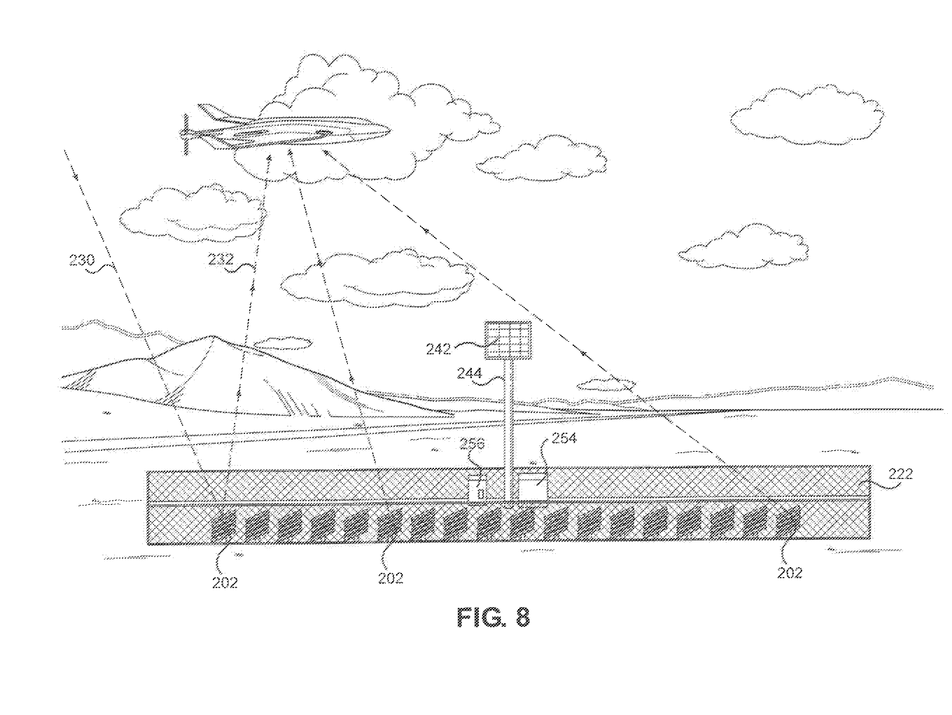

Referring now to FIG. 2, a bottom perspective view of SRA 100 is shown. Solar cells 134 are attached to the lower surface 106 of the body 102 and solar cells 136 are attached to the lower surface 124 of the wings 120. The large surface area of solar cells 134 and 136 allow the SRA 100 to intercept concentrated beam 232 (not shown) from CMA 199 (shown in FIG. 8) at lower angles and hence farther along a flight path. The solar cells 134 and solar cells 136 provide electrical power to the SRA 100 to power motor 150, auxiliary components, and any electrical equipment required to operate the SRA 100. Cooling coils 174 are located within the body 102 and wings 120 and adjacent solar cells 134 and 136 to provide cooling capacity sufficient to cool the solar cells 134 and 136 to optimum operating temperatures. Additionally, air flows on the lower surface 106 of the body 102 and lower surface 124 of the wings 120 to provided additional cooling for solar cells 134 and solar cells 136, respectively.

As will be more fully described below, the present invention beams sunlight ranging from 1 sun (1,000 Watts/m2) up to concentrations of more than 100 suns (100,000 Watts/m2) onto solar cells 134 located on the lower surface 106 of the body 102 and solar cells 136 located on the lower surface 124 of the wing 120. Solar cells 134 and solar cells 136 of the present invention, operating at high efficiencies, absorb the concentrated solar beams 232 (shown in FIG. 8) and convert it into electrical energy for use. The solar cells 134 located on the lower surface 106 of the body 102 and solar cells 136 located on the lower surface 124 of the wing 120 will be high efficiency multi-junction cells having an efficiency better than 40%. As photovoltaic cell technology advances and manufacturing cost decreases, the use of alternative photovoltaic cells with even higher efficiencies and lower cost will be considered and may be used in the alternative.

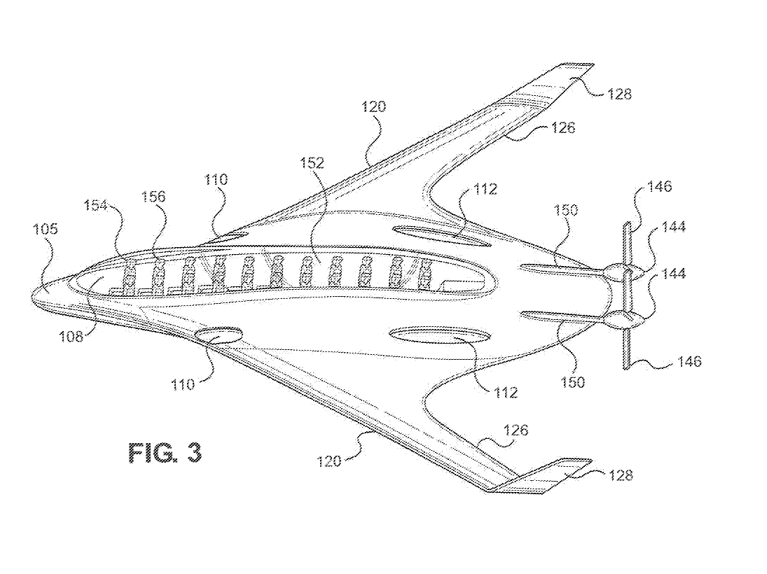

Referring now to FIG. 3, a top perspective view of the preferred embodiment of the SRA 100 is shown. As shown, the canopy 108 covers a passenger compartment 152. The passenger compartment 152 is located in substantially the center of the body 102. This provides greater stability to the SRA 100 while in flight, as the center of gravity for the SRA 100 would be located closer to the physical center of the SRA 100. The passenger compartment 152 houses several passengers 156 in two rows. One row is located on the left of the center line of the body 102 and the other row is located on the right of the center line. Two pilots 154 sit at the front of the passenger compartment 152.

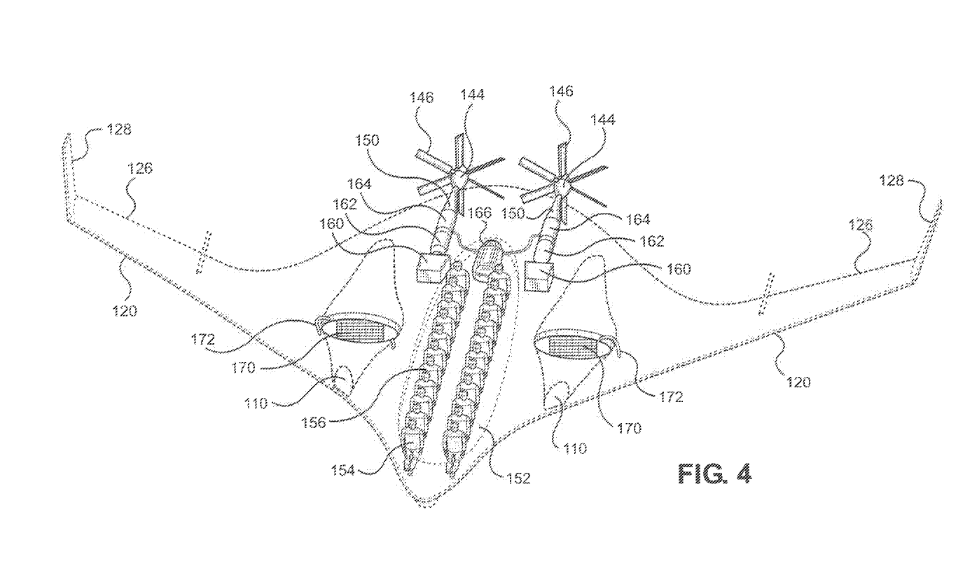

Referring now to FIG. 4, a top perspective view of the preferred embodiment of the SRA 100 having dual propulsion systems is shown. As shown, the pair of drive motors 150 is attached towards the rear of body 102. A propeller 144 formed with blades 146 are attached to each drive motor 150. Each drive motor 150 includes an internal combustion engine 164 and an electric motor 162. The drive motor 150 has the capability of running on the electric motor 162, internal combustion engine 164, or a hybrid option of both the electric motor 162 and internal combustion engine 164 to rotate the attached propeller 144 and create thrust.

The drive motor 150 allows the SRA 100 to compensate for inclement weather, gaps in the heliostat or mirror facilities 200, or additional power requirements. The electric motor 162 generally receives its electrical requirements from solar cells 162 and 164 (not shown in this Figure). However, a battery system 160 provides the electric motor 162 with additional power when needed during takeoff, maneuvers, landing, or during situations where the availability of directed sunlight is diminished. The internal combustion engine 164 receives its fuel from a fuel tank 166. This allows prolonged operation of the drive motor 150 in instances where sunlight and battery power are inadequate to provide the needed propulsion to control the SRA 100.

The air inlet 110 located towards the front of the SRA 100 directs air through a duct in the body 102, pass a radiator 170, and out the air exhaust 112. Ambient cool air entering the air inlet 110 will flow through the radiator 170 and heat up and expand prior to leaving through the air exhaust 112. The additional heat energy added to the ambient cool air may be converted to thrust to compensate for the increased drag caused by the air inlet 110, radiator 170, and air exhaust 112. This is analogous to the thrust generated by a similar radiator on the WWII P-51 Mustang aircraft. The radiator 170 provides cooling to the SRA 100 components such as the solar cells 134 and 136, electric motors 162, internal combustion engines 164, and batteries 160. The radiator 170 is connected to the cooling coils 174 (shown in FIG. 2) located on the lower surface 106 of the body 102 by cooling lines 172. The cooling coils 174 keep the solar cells 134 and 136 at optimum operating temperature.

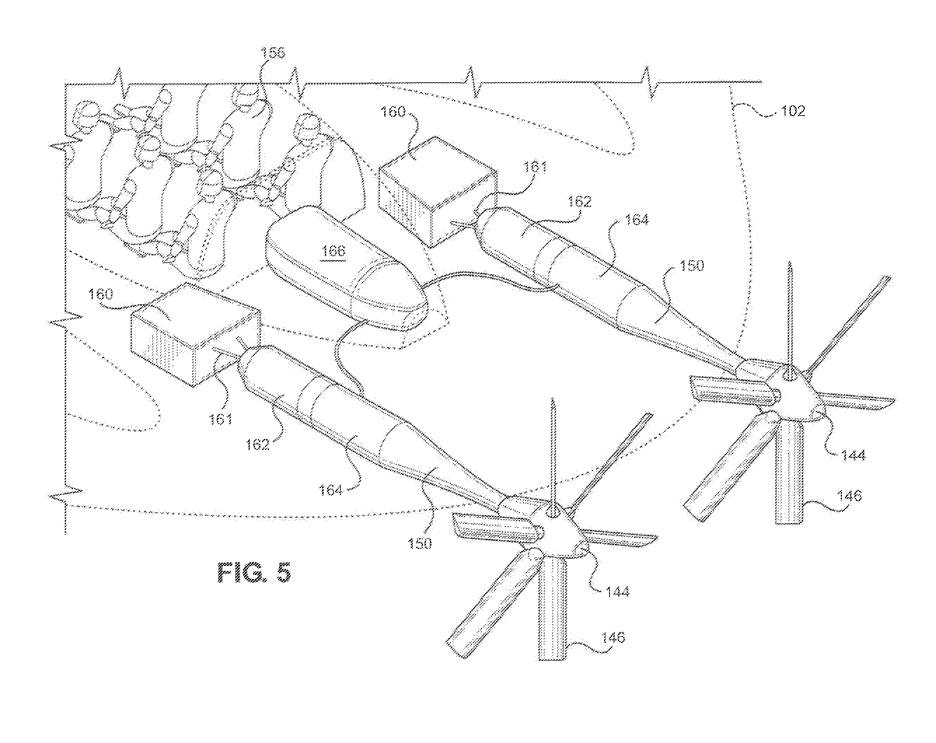

Referring now to FIG. 5, an enlarged view of the dual propulsion systems of SRA 100 is shown. Each drive motor 150 includes an internal combustion engine 164 and electric motor 162. A Propeller 144 formed with blades 146 is attached to each drive motor 150. A fuel line 168 connects the internal combustion engine 164 of each drive motor 150 to a single, common fuel tank 166. The electric motors 162 are connected to their individual battery system 160 by electric cables 161.

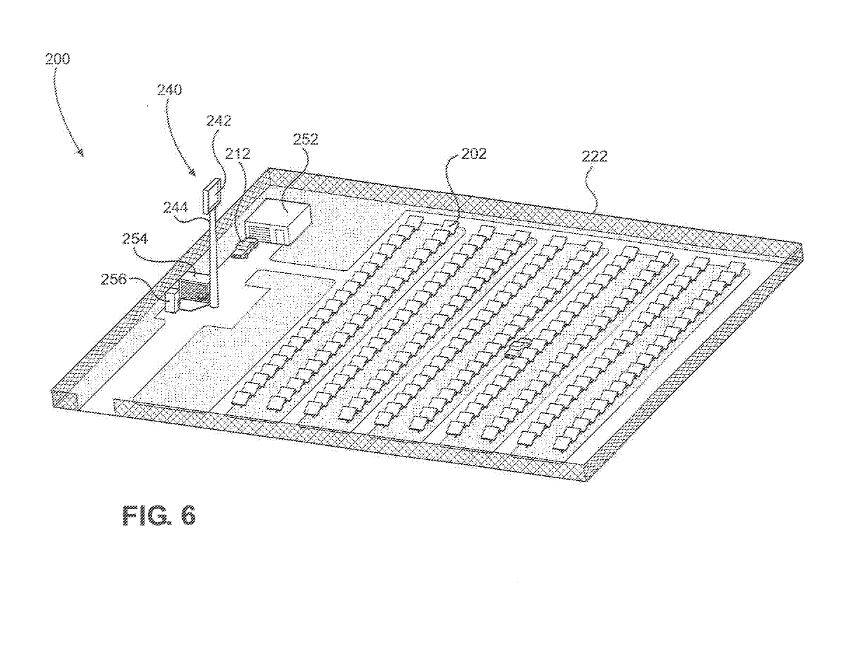

Referring now to FIG. 6, a preferred embodiment of the mirror facility of the present invention is shown and generally designated 200. The mirror facility 200 includes several rows of mirror arrays 202, a power tower 240, a maintenance facility 252, and a maintenance vehicle 212, all surrounded by a fence 222 to reduce wind loads and provide security. As shown, mirror facility 200 includes 10 rows of mirror arrays 202. Each mirror array 202 may be directed towards a single aircraft. As a result, the mirror facility 200 may be directed at multiple aircraft simultaneously such as multiple SRAs 100 or a combination of SRAs 100 and power tower 240.

The power tower 240 is located within the confines of the mirror facility 200 and includes a cooling system 254 and a power inverter 256. The cooling system 254 maintains the solar receiver 242 at optimal operating temperatures to achieve the best efficiency of the solar receiver 242. The power inverter 256 converts the electrical power converted or generated by the solar receiver 242 into a form useable by the power grid, allowing the electrical energy to be fed into the power grid. The power tower 240 provides surplus power to the grid when the mirror arrays 202 are not targeting SRA 100.

Additional infrastructure for the mirror facility 250 can include gravel or paved roads, a differential GPS station, a weather station, radar, optics and telecommunication to track and direct the SRA 100, security sensors and alarms, water and sewer plus electrical power and communication. There can also be housing accommodations for maintenance personnel.

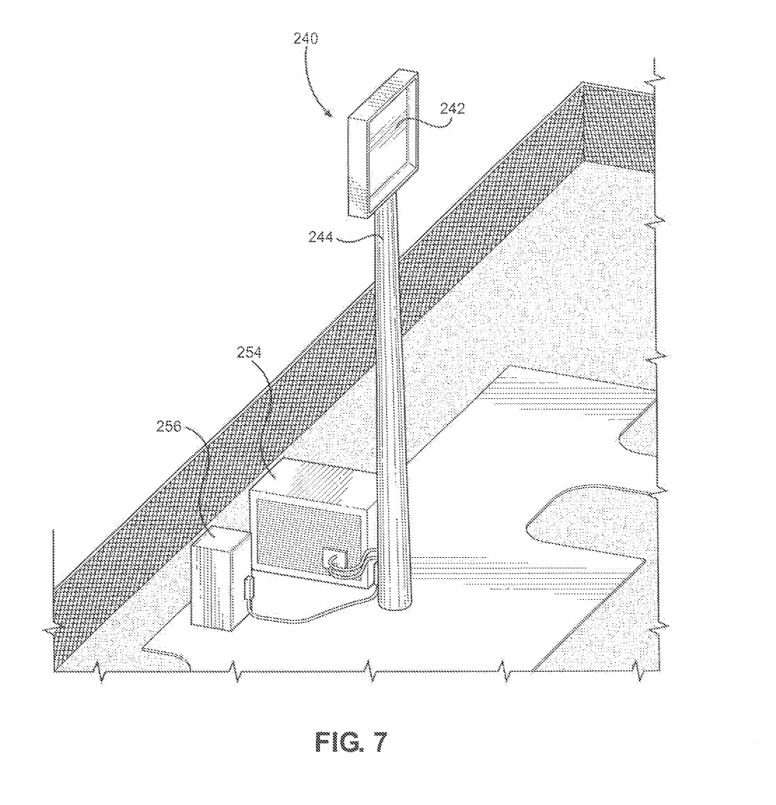

Referring now to FIG. 7, a close up of the power tower 240 is shown. The power tower 240 includes a solar receiver 242 elevated at a predetermined height by support pole 244. The cooling system 254 is connected to the solar receiver 242 and maintains it at optimum temperature to achieve the best efficiency. The power inverter 256 converts the electrical energy generated by the power tower 240 into a useable form to input into the power grid.

Referring now to FIG. 8, a side view of the SRA 100 after initial takeoff is shown gaining elevation while flying over a mirror facility 200 along a desired flight path, with multiple concentrator mirror arrays 202 receiving solar radiation 230 and directing solar radiation 232 towards the SRA 100. As can be appreciated from this Figure, as the SRA 100 moves across the sky above the mirror facility 200, the mirror arrays 202 will adjust their position to maintain position of the reflected solar radiation 232 on the underside of the SRA 100. Once the SRA 100 has passed from view, the mirror arrays 202 will reposition their reflecting surface to direct the solar radiation 232 towards the solar collector 242 of power tower 240.

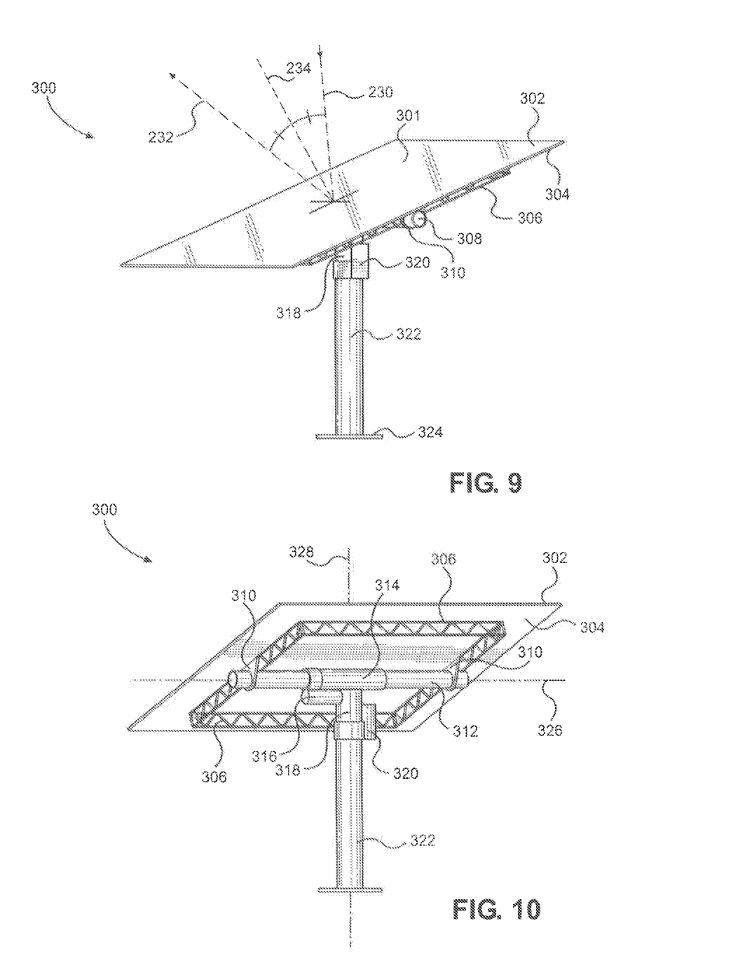

Referring now to FIG. 9, a front perspective view of the preferred embodiment of a mirror assembly of the present invention is shown and generally designated 300. The mirror assembly 300 includes a concentrator mirror 301 supported by a frame 306. On each side of the frame 306, a shaft bracket 310 is rigidly attached at approximately the midpoint. A horizontal shaft 312 is rigidly attached to the bracket 310 and is supported by a vertical shaft 318 and a vertical support 322 attached to a base floor by the base 324.

Each concentrator mirror 301 is, in a preferred embodiment, 2 meters wide by 2 meters long and has a mirror surface 302 and corresponding mirror substrate 304. Various configurations may be used to allow greater concentration of incoming sun rays (not shown) and provide more illumination on the SRA 100 such as varying the number of individual flat mirrors, the material used in the mirror surface 302, and the material used as the mirror substrate 304.

Frame 306 may be planar, or may be slightly curved to accommodate and support the concentrator mirror 301. The curved concentrator mirror 301 ensures the concentrated solar beam 232 (shown in FIG. 8) is focused on the SRA 100. In an alternative embodiment of the concentrator mirror 301 may be composed of multiple mirrors 301 such that multiple superposed solar images are directed to the underside of SRA 100 and depends on the number of individual mirrors used to construct concentrator mirror 301. The mirror surface 302 may be coated with a material which preferentially absorbs that part of the solar spectrum which is not used by the solar cells. This serves the purpose of reducing the heat load on the underside of the SRA 100 by reducing the amount of light reflected by the mirror assembly 300 onto the SRA 100.

To maintain the concentrated solar beam 232 on a target, the reflective surface of the concentrator mirror 301 is kept perpendicular to the bisector lines 234 of the angle between the directions of the sun 230 and the target 232 as seen from the concentrator mirror 301. The target may either be the SRA 100 (not shown) or the power tower 240 (not shown) depending on the circumstances.

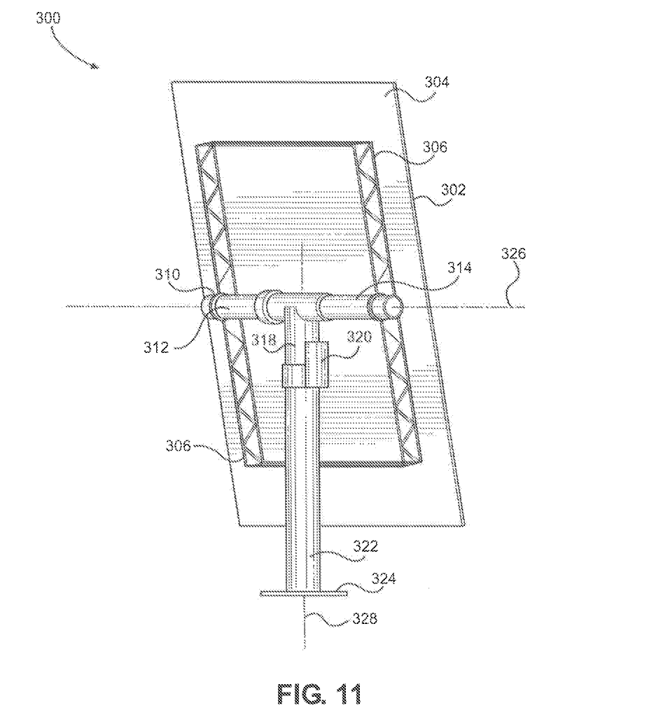

Referring now to FIG. 10 and FIG. 11, a rear perspective view showing the underside of the mirror assembly 300 is shown. The mirror assembly 300 includes a concentrator mirror 301 supported by a frame 306. A shaft bracket 310 is attached to each side of the exterior of frame 306, at a distance approximately at the midpoint. A horizontal shaft 312 is rigidly attached to the bracket 310. The horizontal shaft 312 is inserted through a horizontal sleeve 314. A horizontal drive motor 316 is rigidly attached to the horizontal sleeve 314 and mechanically coupled to the horizontal shaft 312. The horizontal drive motor 316 rotates the horizontal shaft 312 along a horizontal axis 326, thereby causing the rigidly attached frame 306 with concentrator mirror 301 to rotate on the horizontal axis 326.

The horizontal sleeve 314 is rigidly attached to the vertical shaft 318. The vertical shaft 318 is inserted into support pole 322. A vertical drive motor 320 is rigidly attached to the support pole 322 and mechanically coupled to the vertical shaft 318. The vertical drive motor 320 rotates the vertical shaft 318 along a vertical axis 328, thereby causing the rigidly attached horizontal sleeve 314 with attached concentrator mirror 301 to rotate. The vertical support 322 is attached to a base floor by base 324.

The mirror assembly 300 has two axes of rotations, a horizontal axis 326 and a vertical axis 328, to allow articulation of the mirror assembly 300. The wide range of motion allows the mirror assembly 300 to track SRA 100 flying overhead and direct concentrated solar beams 232 to solar cells 134 and 136 located on the lower surface 106 and 124, respectively of SRA 100. This allows the mirror assembly 300 to provide SRA 100 with the illumination required during flight.

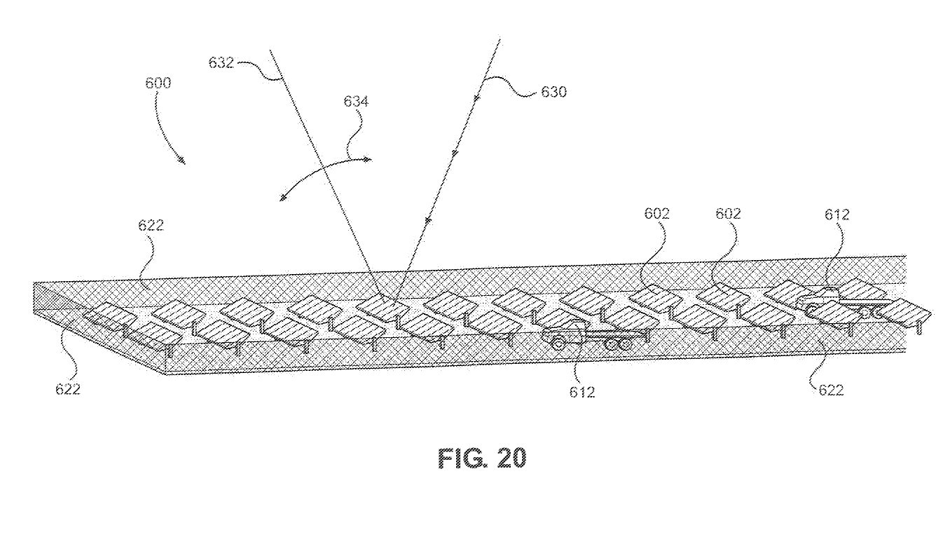

As will be more fully described below in conjunction with FIG. 20, in an alternative embodiment, the mirror assembly can have a single axis of rotation to reduce cost compared to the preferred embodiment with two axes. For instance, Heliostats/mirror assemblies 300 can cost between $100 and $200 per square meter partly due to the second axis. It is expected that the single axis mirror assemblies are to cost $100 per square meter or less due to its simple construction.

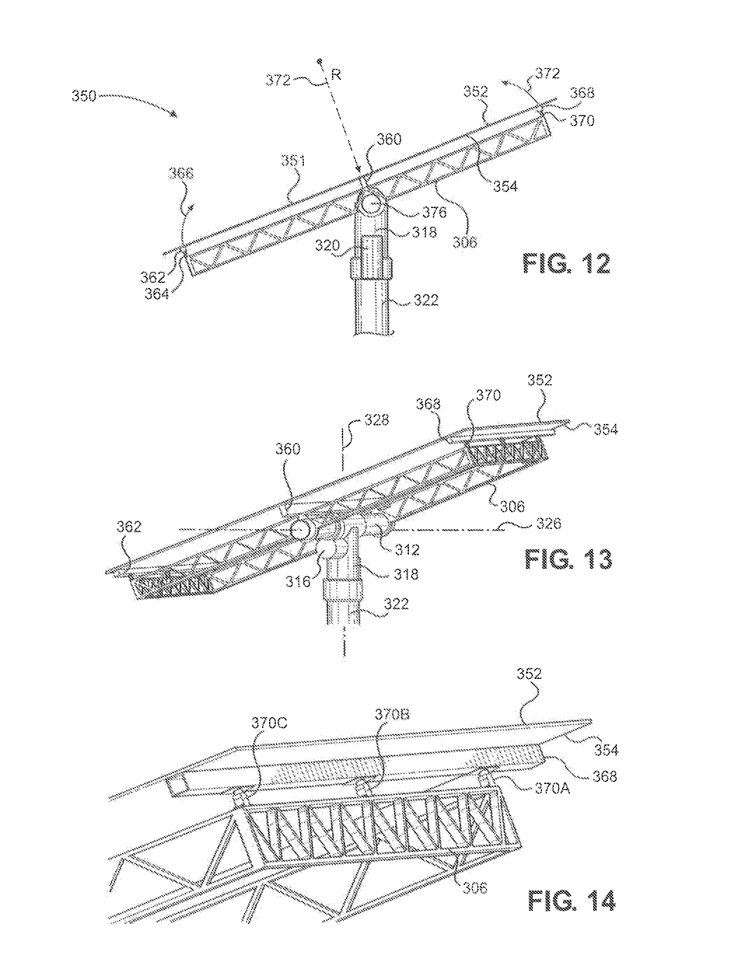

Referring now to FIG. 12, a side view of an alternative preferred embodiment of the mirror assembly of the present invention is shown and generally designated 350. The mirror assembly 350 includes a concentrator mirror 351 supported by a frame 306. The concentrator mirror 351 is made up of an individual mirror. This allows the concentrator mirror 351 to be configured to have a slight curve. Each concentrator mirror 351, in a preferred embodiment, is 2 meters wide by 2 meters long and has a mirror surface 352 and corresponding mirror substrate 354. Various configurations may be used to allow greater concentration of incoming sun rays 230 (shown in FIG. 10) and provide more illumination to a given target, such as SRA 100 or power tower 240.

Frame 306 may be planar, or slightly curved, to accommodate and support the concentrator mirror 351 at a minimum curvature. The concentrator mirror 351 is attached to the frame 306 with a lower lateral brace 362, a central brace 360, and an upper lateral brace 368. The central brace 360 supports the center of the concentrator mirror 351 and is rigidly attached to the frame 306. Upper lateral brace 368 is rigidly attached to the top of concentrator mirror 351 and lower lateral brace 362 is attached towards the bottom of concentrator mirror 351. A plurality of actuators 370 are mechanically coupled to the upper lateral brace 368 and rigidly attached to the frame 306 and a plurality of actuators 364 are mechanically coupled to the lower lateral brace 462 and rigidly attached to the frame 306. The actuators 364 and 370 have the ability to extend or detract in a curvilinear direction. As the actuators 364 and 370 extend, they push the portion of the attached mirror 351 forward along a curvilinear path. As a result, the curvature of the concentrator mirror 451 may be adjusted, resulting in an adjustable radius of curvature 372 and a corresponding adjustable focal length.

In addition to being formed with a radius of curvature 372, the mirror surface 351 may be coated with a material which preferentially absorbs that part of the solar spectrum which is not used by the solar cells. This serves the purpose of reducing the heat load on the underside of the SRA 100 reducing the amount of light reflected by the mirror assembly 350 not used by the SRA 100.

Referring now to FIG. 13, a lower perspective view displaying the underside of the concentrator mirror 351 is shown. The concentrator mirror 351 is attached to frame 306 by the central brace 360, the upper lateral brace 368, and the lower lateral brace 362. The central brace 360 is rigidly attached to the frame 306. The upper lateral brace 368 and lower lateral brace 362 are mechanically coupled to actuators 364 and 370, allowing the mirrors to move along a curvilinear path.

A shaft bracket 310 is attached to each side of the exterior of frame 306, at approximately the midpoint of the frame 306. A horizontal shaft 312 extends across the frame 306 and is rigidly attached to the bracket 310. The horizontal shaft 312 is inserted into a horizontal sleeve 314. A horizontal drive motor 316 is rigidly attached to the horizontal sleeve 314 and mechanically coupled to the horizontal shaft 312. The horizontal drive motor 316 rotates the horizontal shaft 312 along a horizontal axis 326, thereby causing the rigidly attached frame 306 with concentrator mirror 301 to rotate on the horizontal axis 326.

The horizontal sleeve 314 is rigidly attached to a vertical shaft 318. The vertical shaft 318 is inserted into the support pole 322. A vertical drive motor 320 is rigidly attached to the support pole 322 and mechanically coupled to the vertical shaft 318. The vertical drive motor 320 rotates the vertical shaft 318 along a vertical axis 328, thereby causing the rigidly attached horizontal sleeve 314 with attached concentrator mirror 351 to rotate. The vertical support 322 attached to a base floor by the base 324.

The mirror assembly 350 has two axes of rotation, a horizontal axis 326 and a vertical axis 328, to allow articulation of the mirror assembly 350. Additionally, the adjustable radius of curvature 372 of the concentrator mirror 351 allows for a plurality of different focal lengths. The wide range of motion allows the mirror assembly 350 to track a SRA 100 flying overhead and direct concentrated solar beams 232 (not shown) to the underside of the SRA 100. This allows the mirror assembly 350 to provide the SRA 100 with the illumination required to power the SRA 100 during its flight.

Referring now to FIG. 14, a close up view of the mirror assembly 350 is shown. One end of actuators 370a, 370b, and 370c is rigidly attached to the upper lateral brace 368 and the opposite end is mechanically coupled to the rigid frame 306. Multiple actuators 470 are used to reduce the cost and as a redundancy safety measure. Instead of requiring a single powerful actuator, multiple less powerful actuators are used to reduce cost while still providing adequate force. Additionally, by using multiple actuators, in cases where one fails, the remaining operational actuators may compensate for the failed actuator and still configure the concentrator mirror 351 to the desired curvature.

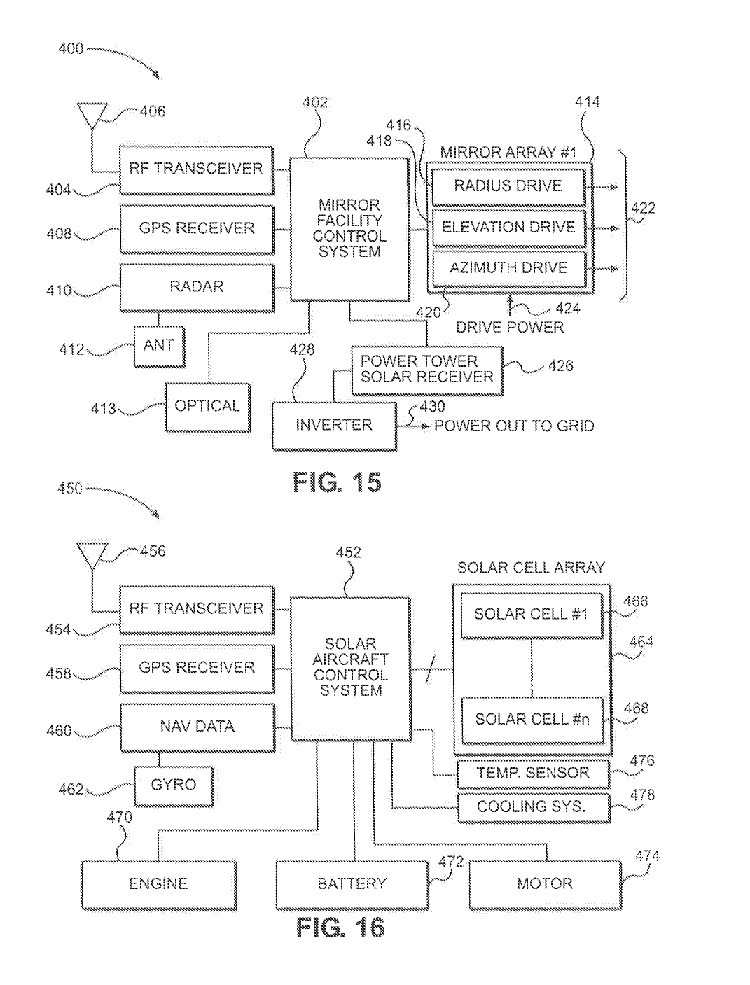

Referring now to FIG. 15, a preferred embodiment of the mirror facility control of the present invention is shown and generally designated 400. The mirror facility control 400 includes a mirror facility control system 402, a radio frequency transceiver 404, a global positioning system receiver 408, a radar 410 and radar antenna 412, an optical tracking system 413, a mirror array controller 414, and power tower solar receiver 426 and inverter 430.

The mirror facility control system 402 is the main processing unit for mirror facility controls 400. The mirror facility control system 402 receives data regarding the SRA 100 (not shown), the sun, and the mirror arrays. The microprocessor combines the precise data of the sun's location, the SRA parameters, such as elevation, speed, and location, and the current position of the mirror assembles to redirect the position of each mirror assembly to illuminate the SRA 100.

The sun's location is readily calculated by utilizing accurate time data and facility location. The GPS receiver 408 provides a time base that is accurate to the sub microsecond and provides the current location of the mirror assembly 300. By utilizing the data gathered and performing calculations, the location of the sun relative to the mirror facility 200 may be determined.

The mirror facility control system 402 receives information regarding the SRA 100 through the RF transceiver 404 and RF antenna 406. The SRA's 100 elevation, speed, pitch angle, and various other metrics regarding the SRA 100 are continually updated and transmitted to mirror facility control 400. The radar 410 and radar antenna 412 track the location of the SRA 100 relative to the location of the mirror facility 200. Additionally, optical tracking may be accomplished with optical tracking device 513 utilized to passively, yet accurately, track the SRA 100 as it passes through the airspace above the mirror facility. By combining all of the data gathered on the SRA 100, the location of the SRA 100 can be precisely calculated.

The mirror facility control system 402 receives information regarding the position of the mirror array 202 through the mirror array control system 414. The mirror array control system 414 includes a radius drive 416, elevation drive 418, and azimuth drive 420. The radius drive 416 receives and transmits data from actuators 364 and 370 of each individual mirror assembly 350 to determine the curvature and focal length of the concentrator mirror 551 (not shown). The elevation drive 418 receives and transmits data regarding the horizontal axis angle of the concentrator mirror 351 from the horizontal drive motor 316 of each individual mirror assembly 350. The azimuth drive 420 receives and transmits data regarding the vertical axis angle of the concentrator mirror 351 from the vertical drive motor 320 of each individual mirror assembly 350. The mirror array control system 414 transmits the information regarding each individual mirror assembly 350 of the mirror array 202 to the mirror facility control system 402. Each mirror array 202 has a proprietary mirror array control system 414 to communicate with the mirror facility control system 402. Accurate position for each individual mirror assembly 350, or 300 for a planar mirror assembly, is calculated based on the gathered data.

By combining the information regarding the location of the sun, the location of the SRA 100, and the position of the mirror arrays 202, the mirror facility 200 can precisely and accurately direct the concentrated solar beam 232 from the mirror arrays 202 to an SRA 100 flying above or to a power tower 240. The mirror facility control system 402 will calculate the new position of the mirror array 202 by utilizing the measured data and programmed lookup tables and transmit positional signals to the mirror array control system 414 which will then forward the positional signals 422 to each individual mirror assembly 300, for example. The positional signals 422 will then activate the corresponding actuator 370, horizontal drive motor 316, or vertical drive motor 320 where a drive power 424 will provide the required power to position the mirror array 202. Due to temperature changes during the day it is expected that significant changes in the heliostat's aim will occur unless periodic calibrations are performed. Therefore each heliostat will be calibrated several times each day by illuminating a target with a known, static location, such as an adjacent power tower 240. This will allow the mirror facility control system 402 to improve the heliostat's pointing accuracy.

One novel feature of the present system is the option to tailor the concentrated solar beam 232 at the SRA 100 such that it peaks near the rear of the SRA 100. This allows the SRA 100 to get a boost in power if it lags slightly in its flight path. Once the SRA 100 lags, the solar cells located at the rear will get extra sunlight and thereby add more power, providing more thrust and accelerating the aircraft back into the optimal position. This is referred to as “solar surfing”.

The mirror facility control system 402 also controls operation of the power tower 240. A power tower solar receiver 426 is connected to and provides power to the mirror facility control system 402 as well as other operational needs of the mirror facility 200. Excess electrical energy not used by the mirror facility control system 402 is directed to inverter 428 which converts the electrical energy compatible with a power grid. The excess energy is then distributed and sold to the grid. Due to the power tower solar receiver 426 being stationary, the mirror facility control system 402 can precisely locate the power tower solar receiver 426 and direct the mirror arrays 200 to reflect concentrated solar beams 232.

Referring now to FIG. 16, a preferred embodiment of the solar aircraft control of the present invention is shown and generally designated 450. The solar aircraft control 450 includes a solar aircraft control system 452, a radio frequency transceiver 454, radio frequency antenna 456, a global positioning system receiver 458, a navigation data 460, a gyro or other inertial navigation devices 462, and solar cell array controller 464. The solar aircraft control system 452 is the main processing unit for solar aircraft control 450. The aircraft control system 452 receives data regarding the SRA 100 (not shown) and mirror facilities 200 (not shown) and utilizes the data for its operational purposes as well as transmits the data to corresponding mirror facilities 200.

A Guidance Navigation and Control system (GNC) may be implemented within the solar aircraft control system 452. The GNC calculates and maintains the SRA 100 on a precise trajectory within a few meters transverse to the optimum flight path. Accurate GNC will be based on Differential Global Positioning System (GPS) using transmitters at the Mirror Facilities 200 and other fixed locations. Differential GPS is an enhancement to Global Positioning System that provides improved location accuracy, from the 15-meter nominal GPS accuracy to about 10 cm in case of the best implementations. Differential GPS uses a network of fixed, ground-based reference stations to broadcast the difference between the positions indicated by the GPS satellite systems and the known fixed positions. These reference stations broadcast the difference between the measured satellite pseudoranges and actual pseudoranges (internally computed based on fixed location), and the receiver stations may correct their satellite pseudoranges with the calculated difference between the measured and actual pseudoranges of the reference stations. The digital correction signal is typically broadcast locally over ground-based transmitters of shorter range. The GPS receiver 458 receives signals from GPS satellite system and the RF transceiver 454 and RF antenna 456 will receive real-time digital correction signal data from reference stations. The GNC of the solar aircraft control system 452 may, due to the more flexible heliostats having both azimuth and elevation control, utilize the data and calculate and maintain the SRA 100 on a precise trajectory within a few meters transverse to the optimum flight path. The solar aircraft control system 452 will be updated several times per second by the GNC to maintain the precision flight trajectory.

The nav data 460 and inertial navigation device, such as gyro, 462 measures the operating parameters of the SRA 100 such as velocity, acceleration, elevation and various other data points needed to operate the SRA 100. A solar cell array control system 464 is in electrical communication with the solar aircraft control system 452. The solar cell array control system 464 monitors and controls solar cells #1 466 up to an infinite number of solar cell #n 468. The solar cell array control system 464 transmits data to the solar aircraft control system 452 regarding the amount of electrical output, illumination, temperature, and various other operating parameters. This aids the solar aircraft control system 452 to determine whether the SRA is on the correct trajectory, whether the solar cells are outputting enough power for the SRA 100, and whether the mirror facilities 200 are directing the concentrated solar beams 232 correctly. The solar aircraft control system 452 is in electrical communication with, and allows the monitoring and control of, electric engine 470, battery 472, and internal combustion motor 474. Additional GNC sensors can include, for instance, conventional GPS plus radar, laser rangefinders and Infrared and Optical cameras.

The RF transceiver 454 and the RF antenna 456 continually transmit data to and receive data from the mirror facilities 200 to ensure the SRA 100 is flying along a precise trajectory and that the mirror facilities 200 are correctly tracking the SRA 100 and directing the concentrated solar beam 232 (not shown) that are required to power the SRA 100. By maintaining a precise trajectory, mirror assemblies 202 of the mirror facilities 200 may generally operate in a single axis of rotation and single focal point. In the event of inadequate illumination the SRA 100 has the capability to run on batteries or the internal combustion engines until the mirror facilities 200 have reacquired the SRA 100. The pilot and co-pilot have authority over the GNC at all times and can be overridden for takeoffs, landings, maneuvers, and non-standard conditions.

In addition to the SRA 100 following a precise trajectory, or flight path, to maintain optimum illumination from the mirror assemblies 300 and 350, the mirror assemblies may also track the SRA 100 and direct the illumination towards the SRA 100, regardless of its trajectory. Indeed, with a two-degree of rotation heliostat 300, the directed beams, such as beams 232 shown in FIG. 9, are constantly and dynamically directed towards the SRA 100 as it traverses the airspace.

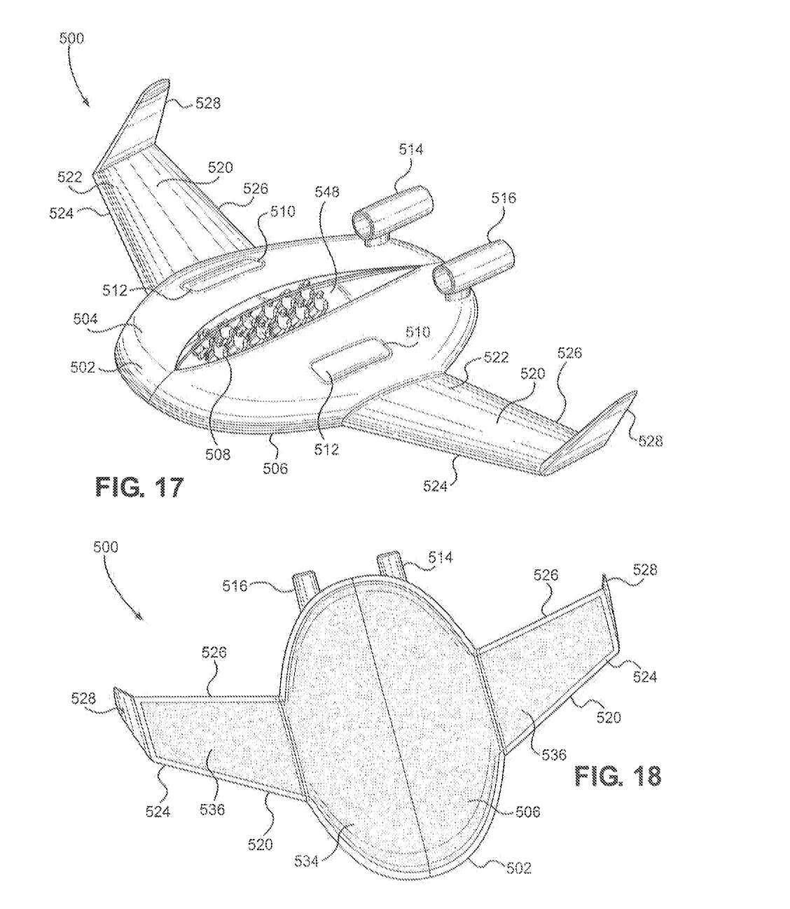

Referring now to FIG. 17, an alternative embodiment of the Solar Relay Airplane of the present invention is shown and generally designated 500. The SRA 500 uses an elongated Blended Wing Body (BWB) which is a lifting body aircraft with wings 520 blended to a body 502. The body 502 of Solar Relay Aircraft (SRA) 500 has the shape of an elongated disc, with the elongation in the direction of the flight path, having an upper surface 504 and a lower surface 506. An elliptical shape was chosen with 40% elongation for the body 502 to enable the SRA 500 to intercept reflected sunlight from a mirror array 202 (not shown in this Figure) at shallow angles and hence farther along a flight path. Each wing 520 is located on either side of the body 502 and extends horizontally outwards. At the end of each wing 520, having an upper surface 522 and a lower surface 524, vertical stabilizers 528 are attached and pointing substantially vertical to improve stability of the SRA 500 while in flight.

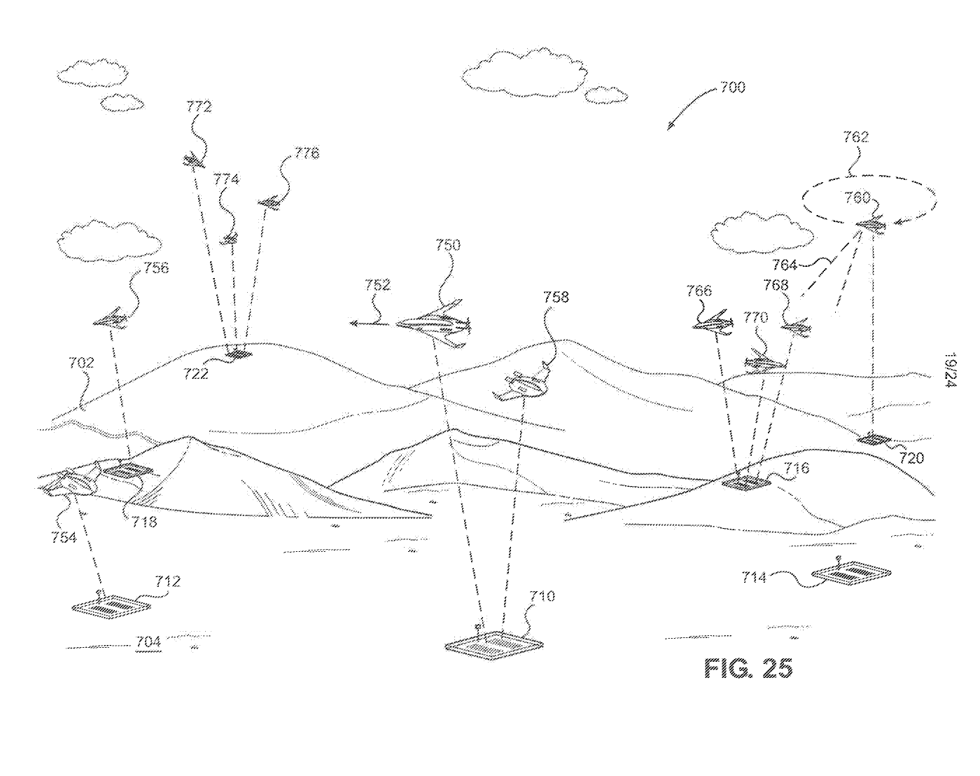

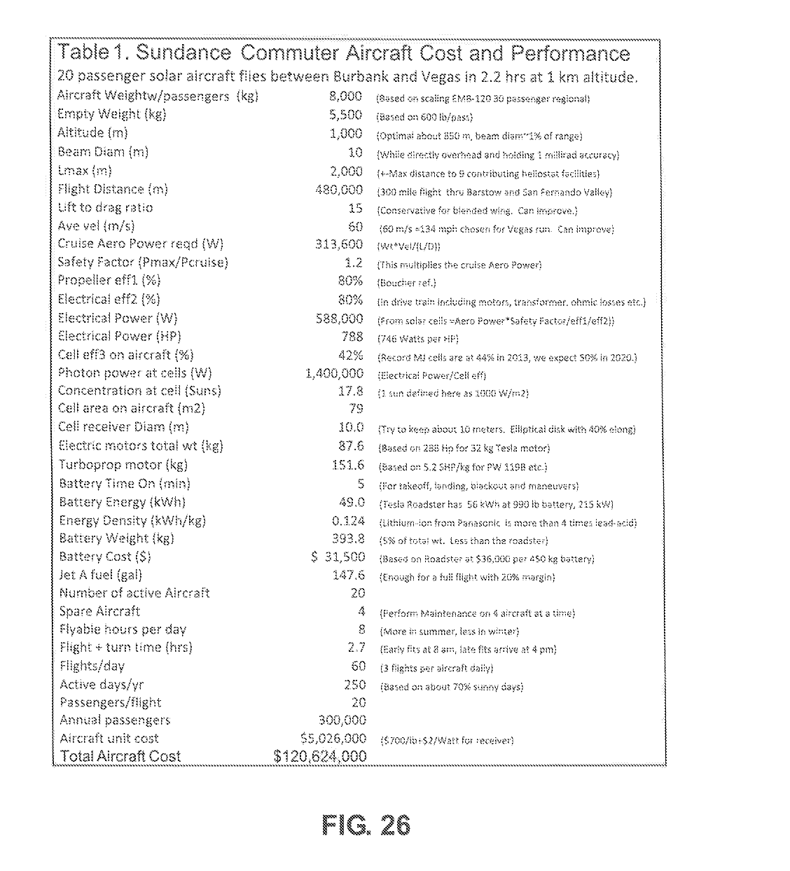

Historically, a BWB aircraft where wings 520 are blended with an elongated elliptical shape similar to body 502 have shown lift to drag (L/D) ratios in excess of 20 in wind tunnels. The preferred embodiment of the SRA 500 has an L/D ratio of 15 as shown in Table 1 of FIG. 25. It is likely that a mature SRA 500 will have an L/D ratio between 15 and 20 as improvements in the L/D ratio of the SRA 500 are expected with further aerodynamic refinements and finer meshes in computational fluid dynamics simulations. Tradeoffs between elongation and aerodynamics will be made to optimize the SRA 500 and mirror array 202 performance.

The upper surface 504 of body 502 includes a battery compartment 510 with a cover 512, and a canopy 508. The cover 512 is removable for access to the battery compartment. Canopy 508 is attached to body 502 and covers a passenger compartment 548 with the ability to accommodate 20 passengers and two pilots. Electric motors 514 and 516 are attached towards the rear of body 502 and provide propulsion for the SRA 500. A small internal combustion engine (not shown this Figure) may be used to supplement the electric motor in a similar fashion to a hybrid car. Alternative forms of propulsion may be available such as a propulsion engine based on a heated fluid such as steam where the steam would power an electric generator or drive a steam engine directly. Steam or another working fluid could also drive a rocket type propulsion engine.

Classic rear engine mounted BWB aircraft have a negative longitudinal static margin of typically around −15% which implies a fly by wire requirement to allow continuous and automatic stabilization of the aircraft. The aerodynamic stability of SRA 500 may be enhanced by either mounting electric motors 514 and 516 near the front of the aircraft or, as shown in FIG. 1, allowing rear mounted motors to transmit the axial force to forward locations via rods which are strong in compression. However, it is preferable to maintain a positive longitudinal static margin for SRA 500 by using the above methods. Alternative, more technically advanced, embodiments of the SRA may incorporate fly-by-wire.

The SRA 500 of the present invention weighs 8,000 kg fully loaded and 5,500 kg empty. It has an approximate 100 ft. wingspan and a length of 56 feet. The SRA 500 has power comparable to a conventional internal combustion powered aircraft such as the Commuter Turboprop EMB 120 Brasilia which seats 30 and weighs 11,500 kg fully loaded.

Referring now to FIG. 18, a bottom view of the alternative embodiment of the SRA 500 of the present invention is shown. Concentrator solar cells 534 are attached to the lower surface 506 of the body 502 and solar cells 536 are attached to the lower surface 524 of the wings 520. It is well known that a flat mirror will project a round solar image at ranges beyond several hundred mirror diameters and the size of the solar image will be approximately 1% of the distance between the mirror and the target. At a cruising altitude of 1 kilometer, it is expected that the projected solar image to be approximately 10 meters, which is 1%×1,000 meters=10 meters. As a result, the lower surface 506 of SRA 500 has an ellipse shape encompassing an area having a 10 meter minor axis and a 14 meter major axis. The 40% elongation of the SRA 500 is chosen to accommodate the projected elongated solar disc coming from distant mirrors at steeper angles along the path.

The large surface area of concentrator solar cells 534 and 536 allows the SRA 500 to intercept concentrated sunlight from the CMA 200 at lower angles and hence farther along a flight path. The solar cells 534 and 536 provides electrical power to the SRA 500 to power electric motors 514 and 516, auxiliary components, and any other equipment requiring electrical power on the SRA 500. During flight, solar cells 534 and solar cells 536 receive high intensity sunlight which results in heat accumulation. A liquid cooling system is provided which removes excess heat from the solar cells 534 and 536 to maintain optimal operating temperatures thereby maintaining their high efficiency. Additionally, convective cooling assists with the removal of excess heat as the air passes over the lower surface 524 of the solar cells 534 and 536. Additionally, the cells are protected from the environment by a coating with good mechanical and thermal properties as well as being anti-reflective and transparent at the wavelengths the cells absorb.

Historically, solar powered airplanes have utilized solar cells or photovoltaic cells only on the top side of the aircraft wing to power the aircraft during the day. Due to the low intensity of un-concentrated sunlight, these aircraft have been somewhat fragile and slow. The present invention's use of ground based solar concentrators plus high efficiency solar cells enables much higher power and thrust levels and hence higher performance and more robust aircraft as compared to traditional solar powered airplanes. The present invention beams sunlight ranging from 1 sun (1,000 Watts/m2) up to concentrations of more than 100 suns (100,000 Watts/m2) onto solar cells 534 located on the lower surface 506 of the body 502 and solar cells 536 located on the lower surface 524 of the wing 520. Solar cells 534 and 536 of the SRA 500, operating at efficiencies as high as 44%, and perhaps even higher as solar technology develops, absorb the concentrated beams of sunlight and convert it into electrical energy for use.

In the preferred embodiment of the SRA 500 of the present invention, the solar cells 534 located on the lower surface 506 of the body 502 and solar cells 536 located on the lower surface 524 of the wing 520 will be higher performance photovoltaic cells referred to as Multi-Junction (MJ) photovoltaic cells. MJ cells incorporate multiple junctions, with each junction tuned to a different wavelength of light, allowing the absorption of a larger spectrum of sunlight thereby increasing efficiency. The MJ cell uses materials such as germanium, indium, arsenic and gallium to utilize more of the suns spectrum. The high efficiency MJ cells work best at higher concentrations, typically between 300 and 1,000 suns. The world record for efficiency is over 44% achieved with a MJ cell. Companies that manufacture MJ cells include Spectrolab, Emcore, Solar Junction and Sharp. However, these sources are not limiting and MJ cells available from other sources are fully contemplated herein.

Currently the record solar cell efficiency is 44% and is anticipated to be near 50% by 2020, thus an improvement in efficiency and power is possible. Since the CMA 200 discussed herein provides sunlight at lower concentrations, an MJ coated SRA 500 may require secondary optics, such as Fresnel or Cassegrain optics, to obtain the optimum concentration of roughly 50 suns as well as requiring close attention to cell cooling to prevent overheating. Later versions of SRAs may use MJ cells operating at 30% to 44% if the economics becomes favorable. It is noted that cell efficiency is a major driver for the CMA 200 cost since for example using cells at 44% instead of 22% will reduce the cost of the CMA 200 by a factor of 2. A preferred version, assuming cell cost decreases, will use MJ cells at over 30% efficiency. It is preferable to avoid secondary optics on the SRA 500 due to complexity and cost. When generalizing ratings of MJ cells, it is anticipated that MJ cells will continue to improve in efficiency, and such higher efficiency cells are fully contemplated in the present invention.

As a lower cost embodiment, high performance silicon based photovoltaic cells may be used. Multiple manufacturers construct silicon based photovoltaic cells having the ability to absorb a larger spectrum of sunlight and absorb concentrated sunlight. For example, NAREC in Great Britain and Sunpower in the USA manufactures silicon based photovoltaic cells having higher efficiencies because they absorb a larger spectrum of sunlight and absorb concentrated sunlight, up to hundreds of suns in the case of NAREC cells or one to seven suns in the case of Sunpower's Maxeon cells, as compared to other manufacturers. In an alternative embodiment of the SRA 500 of the present invention, Sunpower's Maxeon cells may be used and are typically between 15% and 22% efficient. Conservative estimates that have been used are 22%.

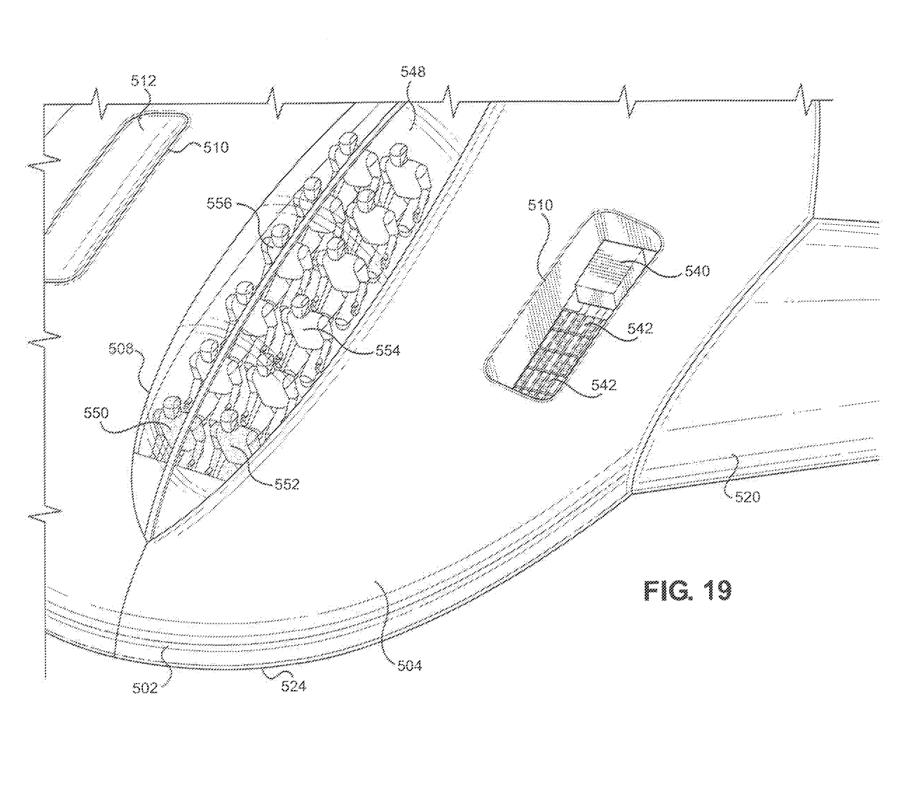

Referring now to FIG. 19, a top perspective view of the solar relay aircraft 500 is shown. The body 502 houses the passenger compartment 548 and is covered by canopy 512. The passenger compartment 548 is located in substantially the center of the body 502. This provides greater stability to the SRA 500 while in flight, as the center of gravity for the SRA 500 would be located closer to the physical center of the SRA 500. As shown, the passenger compartment houses several passengers in two rows. One row 554 of passengers is located on the left of the center line of the body 102 and the other row 556 of passengers is located on the right of the center line. A pilot 550 sits at the front of one row and a co-pilot 552 sits at the front of the alternative row.

The body 502 has two compartments 510, with each compartment 510 located on one side of the body 502 and with cover 512 covering each compartment 510. The cover 512 seals compartment 510 which houses a regulator 540 and a battery pack 542. The SRA electric motors 514 and 516 (not shown) are generally powered by solar cells 534 and 536, respectively. However, when additional power is required such as during takeoff, maneuvers, landing, or during situations where the availability of directed sunlight is diminished, the battery packs 542 provides the additional power needed. Alternatively, other thrust sources, such as turboprop engines, may be incorporated into the SRA. The battery packs 542 will initially be fully charged before flight and will be recharged during flight by solar cells 534 and solar cells 536. The battery packs 542 may also be swapped out with fully charged battery packs after each flight to ensure each flight starts with fully charged batteries. The battery packs 542 are preferably high energy density lithium-ion batteries. Lithium-Ion batteries are the current gold standard for batteries and are used in the preferred embodiment of SRA 500 of the present invention. Zinc-Air and Lithium-Air batteries are being developed which can potentially have more than 3 times the energy per kilogram of Lithium-Ion. When they are mature they may be utilized in the SRAs as well. Fuel cells as well as other energy storage systems may be utilized as they become available and cost efficient.

As shown in FIGS. 17-19, an alternative embodiment of the SRA 500 of the present invention is shown. However, the alternative embodiment is not meant to be limiting. The design of the SRA 500 may be modified based on the needs of the SRA 500 without departing from the scope and spirit of the invention. For example, with higher efficiency solar cells and electric motors, the payload of the aircraft may be increased. The shape of the SRA 500 may be customized to intercept sunlight in particular environments while other shapes may provide better aerodynamics such as a diamond shape or flying wing. Additionally, the SRA 500 may be modified to be used in various environments such as on land, in snow, or in the water.

Referring now to FIG. 20, a perspective view of a preferred embodiment of the mirror facility of the present invention is shown and generally designated 600. As shown, the mirror facility 600 includes multiple mirror arrays 602 surrounded by a fence 622. Each Heliostat or mirror facility 600 is self-contained and fence 622 serves to reduce wind loads and provide security. In the event of high winds, the mirror arrays 602 will rotate to a horizontal low drag configuration.

Each mirror array 602 includes a plurality of mirror assemblies 620. As an incoming sun ray 230 reaches the individual mirror assemblies 620, the incoming sun ray 630 is reflected at a predetermined skew angle 634 and a concentrated solar beam 232 is directed towards a target location, such as towards an SRA 100 or 500 (not shown) or a power tower 240 (not shown). The mirror arrays 602 are able to reflect sunlight at angles between 10 to 90 degrees from horizontal and deliver concentrated solar beam 632 up to 5,000 meters away. To allow the optimum amount of sunlight to be reflected off of the mirror array 602, any dust accumulating on the mirror array 602 will be removed by periodic washing either by a service vehicle 612 or automatic sprayers (not shown).

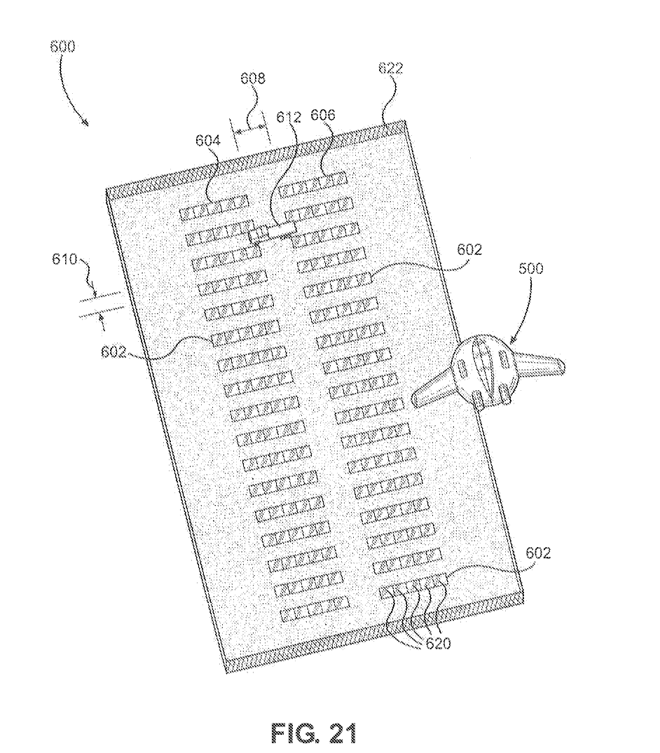

Referring now to FIG. 21, a top view of the mirror facility 600 is shown with a SRA 500 flying overhead. As shown, the mirror arrays 602 are organized into two rows, specifically mirror array row 604 and mirror array row 606. Each mirror array 602 is separated by a row-to-row distance 608 and an array-to-array distance 610. By separating each mirror array 602 by a predetermined distance, it allows the mirror arrays 602 to articulate without interference from other mirror arrays 602. Additionally, the predetermined distance provides clearance to prevent successive mirror arrays 602 from obstructing the concentrated solar beam 632 (shown in FIG. 20) of other mirror arrays 602 from reaching its target destination. A mirror facility 600 may contain several hundred mirror arrays 602, or heliostats, which are made of several mirror assemblies 620.

As an SRA 500 comes into range of a mirror facility 600, the control system of the mirror facility 600 tracks the trajectory of the SRA 500 flying along a predetermined flight path. The mirror facility 600 then adjusts the mirror arrays 602 to direct concentrated a solar beam 632 (not shown) to solar cells 534 and 536 of the SRA 500, whereby the solar cells 534 and 536 converts it into electrical power for use. The mirror facility 600 beams a concentrated solar beam 632 ranging from 1 sun (1,000 Watts/m2) up to concentrations of more than 100 suns (100,000 Watts/m2). Alternatively, a nearly stationary viewing or circling observation platform can be powered by a small number of mirror facilities 600 as long as it stays within range of the concentrated solar beam 632.

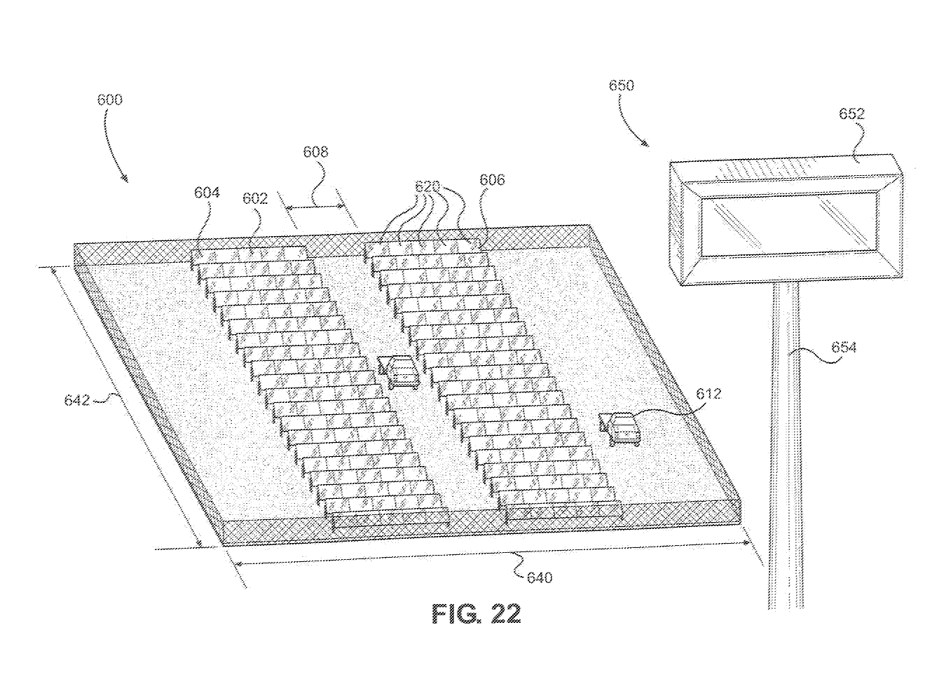

Referring now to FIG. 22, a mirror facility 600 is shown having a power tower 650. The power tower 650 includes a solar receiver 652 supported by a support pole 654. The support pole 654 elevates the solar receiver 652 a predetermined height to enable all of the mirror assemblies 620 of the mirror facility 600 to concentrate and reflect incoming sun rays 630 (not shown) as concentrated solar beams 632 (not shown) onto the solar receiver 652. The solar receiver 652 converts the concentrated solar beams 632 into electricity. There are multiple types of solar receivers 642 which will readily work. For instance, a first type is a Rankine Cycle steam turbine, which utilizes the heat generated from the concentrated solar beams 632 illuminating the solar receiver 652 to convert water into steam which in turn powers a turbine to generate electricity. Another type is a photovoltaic receiver made with concentrator solar cells similar to solar cells 134 and 136. The power tower 650 will require not only power generation but also power conditioning including step up transformers. In a preferred embodiment, the CMA 600 of the present invention is dual use. The CMA 600 provides concentrated solar power to power SRA 500 and also energizes solar power towers 650 to provide power to the grid.

In an alternative embodiment of the present invention, mirror assemblies 602 do not have a transverse rotation axis. Specifically, mirror assemblies 620 in mirror array 602 may only rotate on a horizontal axis to track a SRA 500 directly overhead on a predetermined flight path. In this case, the solar receiver 650 may have the ability to translate, or move, in a direction transverse to the flight path in order to position the solar collector 652 in position to receive the reflected solar energy. In addition, due to seasonal changes in the sun's apparent trajectory the power tower 650 may require translation during each season. Keeping the power tower 650 near the mirror facility 600 will reduce the height and translation requirements. A compact power tower 650 may reduce capital cost and maintenance.

A mirror module is defined as a number of consecutive mirror facilities 600 along a flight path that illuminate an SRA 500 at one time. The remaining mirror facilities 600 along the flight path not being used to illuminate the SRA 500 may be utilized to illuminate the corresponding power towers 650. After the SRA 500 has passed out of range of a mirror facility 600, the mirror facility 600 can return its focus to its respective power towers 650. The mirror facilities 600 are continuously being utilized to provide power to the SRA 500 or power towers 650, maximizing the cost to benefit ratio of the Heliostat or mirror facilities.

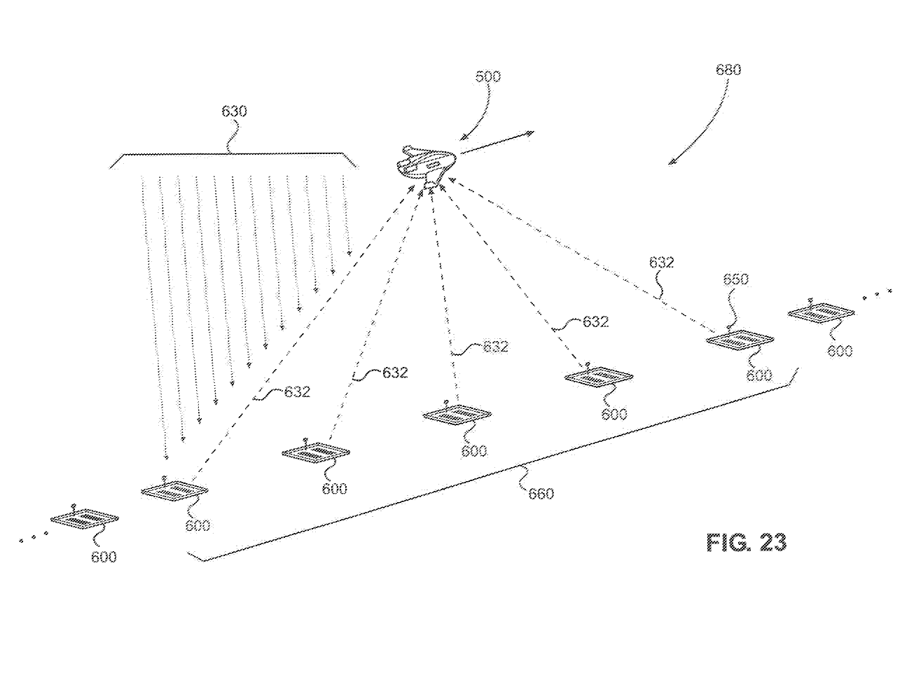

Referring now to FIG. 23, a perspective view of the present invention is shown with a SRA 500 flying along a flight path. All mirror facilities constructed along the length of a flight path are collectively referred to as a concentrator mirror array (CMA) 680. Within a CMA, there are several mirror facilities 600 which are illuminating an SRA 500 at any one time, and which are referred collectively as a mirror module 660. In an exemplary example, the point of travel is between Burbank, Calif. and Las Vegas, Nev. with a total distance of approximately 480 kilometers. In this example, mirror module 660 includes multiple mirror facilities 600 which are constructed along the length of the flight path and are located 500 meters apart from one another. For the length of the flight path, there are a total of 960 mirror facilities 600 making up the mirror module 660. A CMA 680 includes all the mirror facilities 600 along the route. The flight path and travel distance from Burbank, Calif. to Las Vegas, Nev. is only an exemplary example and is not meant to be limiting. The mirror facility 600 is configurable to be used in areas of moderate to high solar insolation, such as between Las Vegas and Los Angeles in the USA or between Alice Springs and Adelaide in Australia. Various flight paths and travels distances may be considered. Increasing or decreasing the distance of travel will affect the total amount of mirror facilities 600 included in the CMA 680.

In a preferred embodiment, there are five (5) successive mirror facilities 600 in a mirror module 660 focusing at one SRA 500 at any point during its flight. Each mirror facility 200 is located 2 km apart and hence a mirror module 290, in this example, covers a ten (10) kilometer span.

In an alternative embodiment of the present invention, there may be nine (9) successive mirror facilities 600 focusing at one SRA 500 at any point during its flight. The combination of these nine (9) mirror facilities 600 also forms a mirror module. Each mirror facility 600 is located 500 meters apart and hence a mirror module 660 covers a four (4) kilometer span.

In one application of the present invention, the SRA 500 flies at one (1) kilometer altitude above the mirror facilities 600. As the SRA 500 progressively moves along its flight path, the first mirror facility 600 in the mirror module will begin to get further away and eventually the concentrated solar beam 232 will be unable to reach SRA 500. However, the distance between the SRA 500 and next successive mirror facility 600 along the flight path will decrease, eventually being able to receive the full concentrated solar beam 232 of that mirror facility 600 and thereby eventually replacing the first mirror facility 600 that is out of reach with the new mirror facility within reach. As the SRA 500 progressively moves along its flight path, the continual replacement of mirror facilities 600 ensures there are nine (9) mirror facilities 600 in the mirror module concentrating on the SRA 500 at any one time. This ensures the SRA 500 receives the full power of the mirror module as it progresses along its flight path.

The mirror facility 600 continually tracks the SRA 500 as it flies along the flight path and continually changes its skew angle 234 to allow concentrated solar beam 232 to illuminate solar cells 534 and 536. As the SRA 500 gets closer to the heliostat or mirror facilities 600, the skew angle 234 gets more perpendicular and as the SRA 500 moves further away from the mirror facility 600, the skew angle 234 becomes steeper.

### OPERATION OF THE PRESENT INVENTION

As shown in FIG. 23, a high performance SRA 500 as described herein is flying over a CMA 680 while on its flight path. The mirror facilities 600 located on the ground along the flight path concentrates and reflects incoming sun rays 630 into concentrated solar beams 632. The concentrated solar beams 632 illuminates the solar cells 534 located on the lower surface 506 of the body 502 and solar cells 536 located on the lower surface 524 of the wing 520. Unlike conventional solar powered aircraft, the SRA 500 has solar cells on the bottom portion of the aircraft instead of the top. The SRA 500 may also have low power cells on the top to supplement the power output of SRA 500. The silicon multi-junction solar cells 534 and 536 run at higher illumination and create higher current than conventional one sun cells. As a result, the SRA 500 has power comparable to conventional internal combustion powered aircraft such as the Cessna Caravan 208 which seats 9 and weighs 4,000 kg fully loaded. Table 1 of FIG. 25 below shows the aircraft performance.

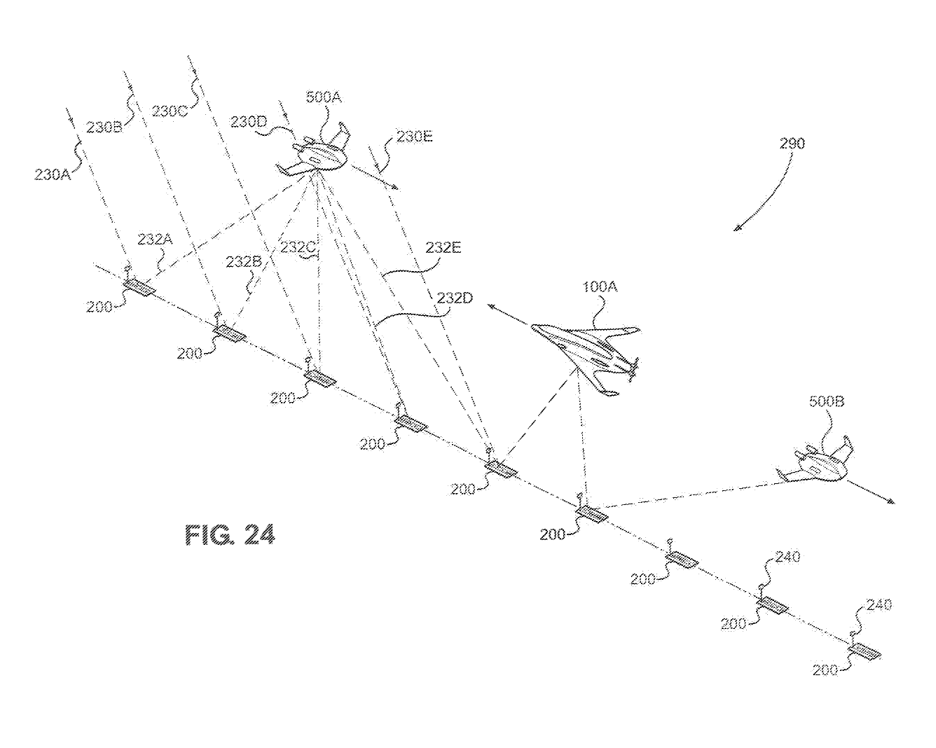

Referring now to FIG. 24, three SRAs 100a, 500a, and 500b are shown flying simultaneously over a portion of a CMA 199. As shown, only a portion of a mirror module 290 of each SRA 100a, 500a, and 500b is shown. Each mirror module 290 includes nine (9) individual, successive mirror facilities 200. Each mirror facility 200 has the capability to illuminate multiple SRAs simultaneously, allowing a single mirror facility 200 to be included into several mirror modules. As a result, multiple SRAs may be in flight simultaneously, using the same flight path. As shown, SRAs 100a, 500a, and 500b are shown flying on the same flight path with SRA 500a and SRA 500b flying in the same direction and SRA 100a flying in the opposite direction.

Typical operation of the system of the present invention includes first checking the weather along the flight path for sunlight, wind, clouds and other environmental factors which may affect the flight for the SRA. If there is adequate sunlight and fair weather and the SRA and CMAs 202 are fully operational, the flight is authorized by a flight control tower. The SRA will take off from a runway using a fully charged set of batteries. The SRA may utilize the battery powered electric motors or the integrated internal combustion engine to aid during takeoff. Additionally, during the duration of the flight the SRA has the option to use battery power to run the electric motors or the internal combustion motors when needed. Once the SRA reaches an adequate elevation, the first mirror facility 200 illuminates the SRA, directing concentrated solar energy on SRA solar cells. For example, during a flight with an SRA 100, solar cells 134 and 136 of the SRA 100 would receive the concentrated solar energy to enable the SRA 100 to climb in elevation. Meanwhile, the Mirror Facility Controllers 400 of successive mirror facilities 200 in the CMA synchronize their mirror arrays 202 to the SRA 100 based on the data transmitted from the SRA 100 and gathered from various sensors. As the SRA 100 flies further along the flight path, mirror facilities 200, separated by roughly 2 km, will illuminate the solar cells of SRA 100, forming a mirror module 290 as shown in FIG. 24.

The mirror module 290 provides the illumination required to power the SRA 100 using only the electrical energy converted from the concentrated solar beams 232. A portion of the electrical energy is used to recharge the battery onboard the SRA 100 and power electrical equipment onboard the SRA 100. As the SRA 100 progressively moves along its flight path, the continuous replacement of heliostat or mirror facilities 200 in the mirror module 290 occurs along the CMA, ensuring nine (9) mirror facilities 200 are in the mirror module 290 at all times. During cruise, the SRA 100 autopilot may be fully engaged with the option for the pilot to override. If the SRA 100 encounters large gaps between mirror facilities 200 or must make maneuvers requiring additional electrical energy, the additional power needed will be provided by the lithium-ion batteries or the internal combustion engines.

There may be more than one SRA 100 flying and so the mirror facility 200 will intelligently decide which SRA 100 to illuminate so as not to compromise performance. Outbound and inbound SRAs 100 pass by each other at different altitudes having several hundred meters of separation. Based on the alternative embodiment of the mirror facility 200, the mirror facility 200 has multiple rows of mirror arrays 202 with the ability to focus a pair of mirror arrays 202 to a target SRA 100. This allows multiple mirror modules 290 to encompass one mirror facility 250 when multiple SRAs 100 will be flying over the same mirror facility 250. In the preferred embodiment of the mirror facility 200, the mirror facility has a single pair of mirror array 202 rows. In this instance, based on a 120 m/s closing speed and a 4 km interaction distance there will be about 30 seconds per interaction during which SRAs will experience diminished illumination due to multiple SRAs 100 having mirror modules 290 encompassing the same mirror facilities 200. This will be compensated for by the battery or the internal combustion engine. Mirror facilities 200 not currently a part of a mirror module 290 are directed to the nearest solar power tower 240. The mirror arrays 202 of the mirror facility 200 will illuminate the solar receiver 242 of the solar power tower 240 and provide power to mirror facility 200 and the grid.

When the SRA 100 reaches or approaches its destination the pilot can land it on the runway or let the autopilot perform the landing. From then on, the passengers and cargo will disembark as per a conventional aircraft. After the SRA 100 is checked and serviced (including a fresh battery swap if needed) it is ready to provide another flight.

Referring now to FIG. 25, a is perspective view of an alternative embodiment of the system of the present invention is shown, generally designated 700, and includes an installation with a number of mirror facilities servicing a variety of solar relay aircraft each having differing flight paths. This installation can extend through different geographic regions, such as mountains 702 and desert 704, for example. These examples, however, are merely exemplary and the present invention may be operated in virtually any environment.

A number of mirror facilities are installed throughout the region. For example, mirror facilities 710, 712 and 714 may be installed in low flatlands such as desert. Mirror facilities 716 and 718 may be installed in foothills or lower mountains. Mirror facilities 720 and 722 may be installed in higher mountainous regions. It is to be appreciated that the mirror facilities shown are merely exemplary of a typical installation of a preferred embodiment, and are not in any way to be considered limiting to the spirit or scope of the present invention. Also, mirror facilities may be smaller (with fewer mirror arrays) or larger (with a larger number of mirror arrays) depending on the number of SRA to be serviced simultaneously by the mirror facility, and the intensity of the solar energy to be delivered to the SRA.

FIG. 25 depicts several SRA, with some SRA simultaneously passing overhead on different flight paths, some flying circular recharging flight paths, and others flying reconnaissance and receiving reflected solar energy from one of many different mirror facilities. For instance, SRA 750 is passing over mirror facility 710 and flying in direction 752, while SRA 754 is passing over mirror facility 712. These two SRA can pass over adjacent mirror facilities, and each may be simultaneously illuminated by the adjacent mirror facility as shown above in conjunction with FIGS. 23 and 24. SRA 758 can be flying away from mirror facility 710, passing over adjacent mirror facility 714, or may be circling mirror facility 710 to charge its battery bank for later nighttime or remote location flights.

Another use of the present invention is to provide a centralized charging station for multiple SRA, such as mirror facility 716. As shown, mirror facility 716 is simultaneously directing solar radiation to SRA 766, 768 and 770. In this application, these SRA can be flying in a holding pattern, maintaining full battery charge, before being deployed away from mirror facility 716 for a specific flight mission, such as a payload delivery, a reconnaissance mission, or any other purpose of the SRA flight. Similarly, multiple mirror facilities may provide similar charge maintenance services, such as mirror facility 722 located remotely in the mountains 702, and servicing SRA 772, 774 and 776. SRA 760 is maintaining a circular flight pattern 762 over mirror facility 720 and engaged in surveillance as depicted by dashed lines 764.

The SRA depicted in FIG. 25 include both SRA 100 and SRA 500 as described above. It is to be appreciated, however, that other SRA having a downward-facing solar collector capable of receiving solar energy at multiple-sun intensities are fully contemplated herein, and do not depart from the present invention.

While three SRA have been shown in flight above a single mirror facility, such as mirror facilities 720 and 722, it is to be appreciated that the number of SRA serviced by any one mirror facility depends on the solar energy requirements for each SRA, the size of the mirror facility and the number of mirror arrays therein, as well as other environmental factors, such as solar intensity, cloud cover, etc. Also, one SRA may have a drastically different solar energy requirement than another SRA, yet all types of SRA can be serviced by a single mirror facility.

Each mirror facility shown in FIG. 700 includes a corresponding power tower as discussed above. In this configuration, each mirror facility is self-sufficient requiring no electricity from outside sources for operation, and thus suits the present invention well for deployment in remote locations. Moreover, by providing multiple mirror facilities in remote regions, if one facility is performing maintenance, becomes damaged or otherwise unavailable, SRA can be easily redirected to neighboring mirror facilities to receive their necessary charging to ensure prolonged flight times.

The system of the present invention allows for the solar powered delivery of commuters and goods between locations, transmission and reception of high bandwidth communication, as well as surveillance and reconnaissance. A preferred embodiment of the SRA 100 of the present invention nominally does not consume any hydrocarbon fuel nor do they emit any carbon dioxide. Major benefits to the present invention include the following: rapid and affordable solar powered aircraft transportation with substantial payloads; little or zero hydrocarbon fuel usage and commensurately near zero carbon dioxide emissions; renewable, zero emission and comparatively affordable grid electric power generated at those same locations.

Referring now to FIG. 26, Table 1 shows the performance of the preferred embodiment of the present invention. Table 1 shows the performance of a SRA 100 with 20 passengers flying between Burbank. California and Las Vegas, Nev. in 2.2 hours at 1 kilometer altitude.

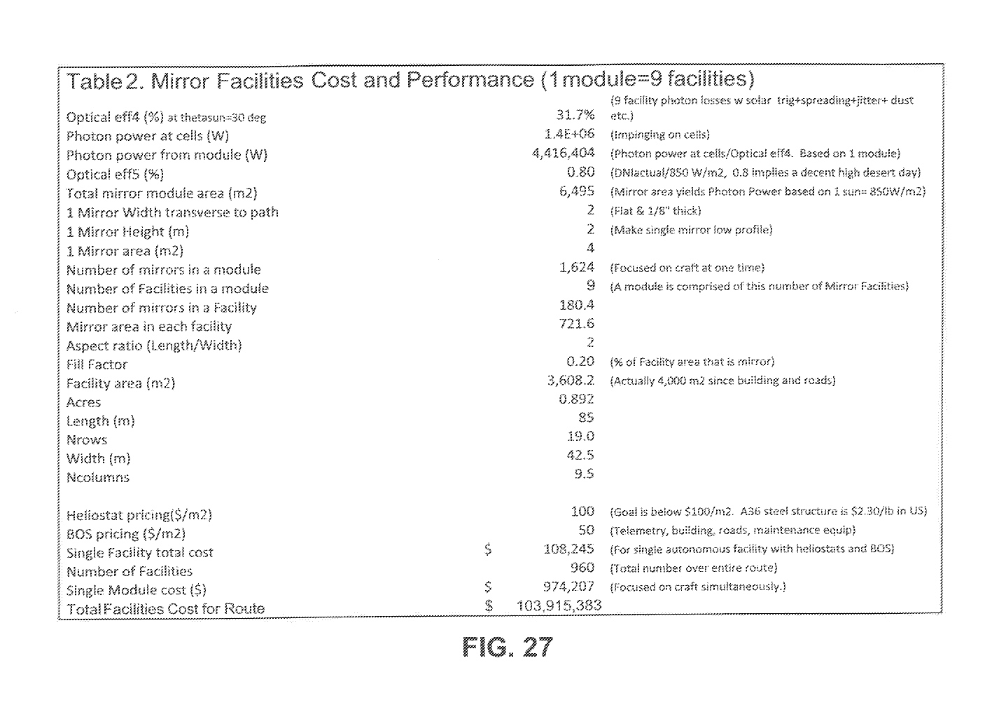

Referring now to FIG. 27, Table 2 shows the cost and performance of the concentrate mirror array of the present invention.

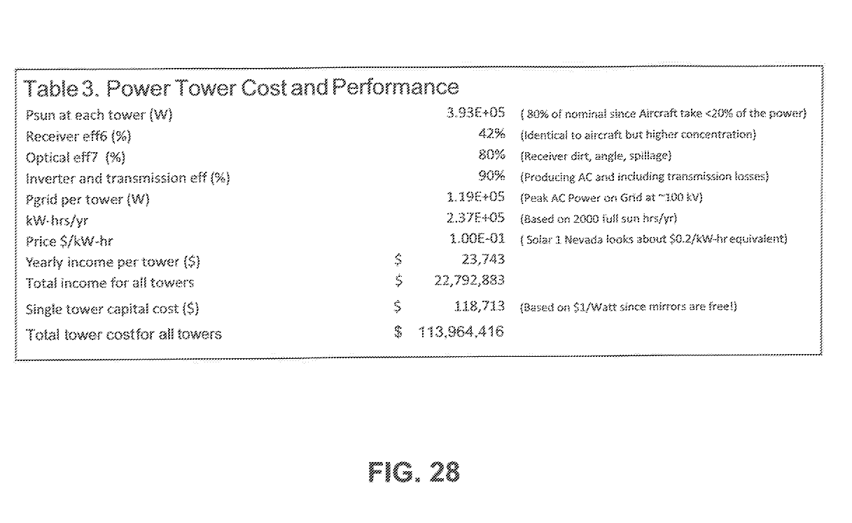

Referring now to FIG. 28, Table 3 shows the cost of the total number of power towers in a concentrated mirror array and its performance.

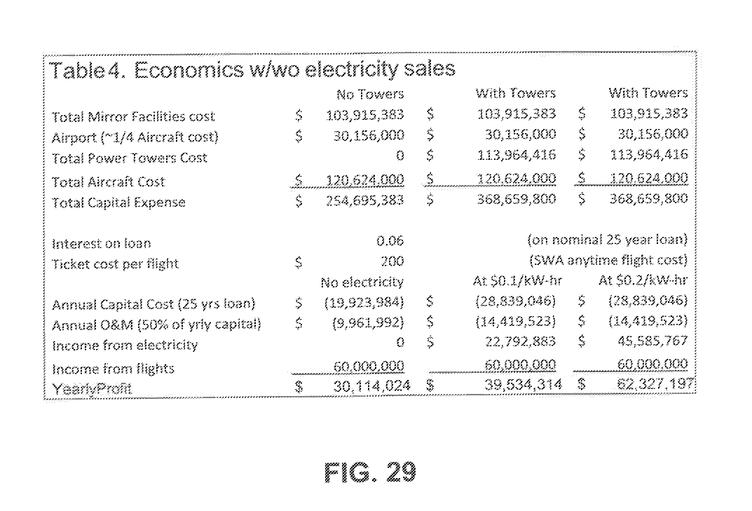

Referring now to FIG. 29, Table 4 shows the economics of the entire SRA, CMA and Power Tower System. The Power Tower option appears favorable for example when power can be sold to the grid at $0.20 per kWh, but may not be favorable if the Power Tower itself is expensive or grid power is cheap. The example shows a yearly profit of $30M, 28M and $40M for the cases of no Power Tower, Power Tower selling electricity at $0.10 per kWh and $0.2 per kWh respectively. In all cases, the SRA ticket sales contribute strongly to the profit. The UAV reconnaissance version may prove out economically in the event that it is utilized in high DNI locations. The Broad Band communication relay version may also prove viable as a way to enhance connectivity and augment satellite or radio tower performance.

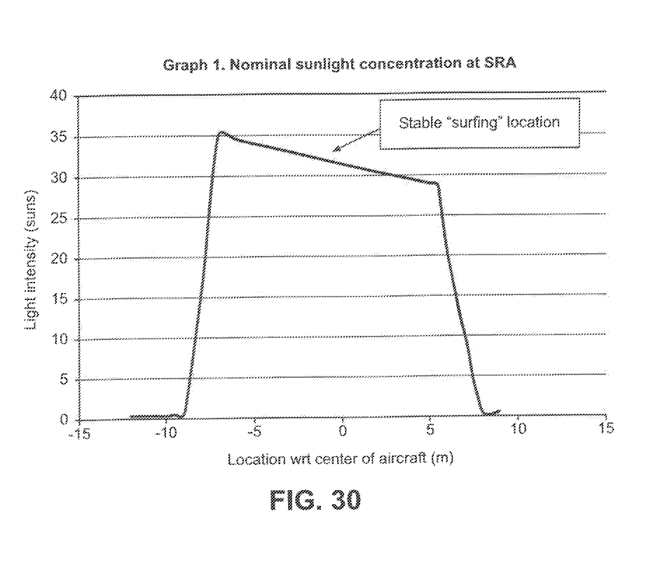

Referring now to FIG. 30, Graph 1 shows the nominal sunlight concentrations at the SRA, and details the operational characteristics of a stable “surfing” location on the graph.

While there have been shown what are presently considered to be preferred embodiments of the present invention, it will be apparent to those skilled in the art that various changes and modifications can be made herein without departing from the scope and spirit of the invention.

I claim:

1. A solar relay aircraft system, comprising:
a solar relay aircraft having an upper surface, and a lower surface;
a solar radiation receiver on said lower surface and capable of converting solar energy to electrical energy;
an electric motor mechanically coupled to a propeller and in electrical connection with said solar radiation receiver to receive said electrical energy; and
a means for directing said solar radiation from the sun towards said solar relay aircraft.

2. The solar relay aircraft system of claim 1, wherein said means for directing said solar radiation comprises a ground-based reflector array for receiving solar radiation from the sun.

3. The solar relay aircraft system of claim 1, wherein said means for directing said solar radiation further comprises at least one ground-based mirror array having a reflective surface for directing said solar radiation to said solar radiation receiver on said solar relay aircraft.

4. The solar relay aircraft system of claim 1, wherein said means for directing said solar radiation further comprises at least one concentrator mirror assembly to direct solar radiation towards said solar radiation receiver.

5. The solar relay aircraft system of claim 4, wherein said concentrator mirror assembly comprises a plurality of mirror arrays.

6. The solar relay aircraft system of claim 1, wherein said means for directing said solar radiation further comprises a heliostat capable of adjustment in elevation and azimuth.

7. The solar relay aircraft system of claim 6, wherein said heliostat further comprises:
a base defining a vertical axis and extending upwards to a vertical shaft capable of rotation on said vertical axis;
a horizontal sleeve defining a horizontal axis and attached to said vertical shaft and having a horizontal shaft coaxial with said horizontal sleeve and capable of rotation on said horizontal axis;
a frame attached to said horizontal shaft;
a mirror substrate attached to said frame, and having a mirror surface opposite said frame;
a vertical drive motor coupled to said vertical shaft to rotate said horizontal sleeve; and
a horizontal drive motor coupled to said horizontal shaft to rotate said horizontal shaft.

8. The solar relay aircraft system of claim 1, wherein said means for directing said solar radiation provides solar radiation having an intensity ranging between 1 to 100 suns.

9. The solar relay aircraft system of claim 1, further comprising:
a battery pack in electrical communication with said solar radiation receiver; and
a regulator in electrical communication with said solar radiation receiver and said batter pack to receive said electrical energy from said solar radiation receiver.

10. The solar relay aircraft system of claim 1, wherein said solar radiation receiver comprises concentrator multi-junction solar cells.

11. The solar relay aircraft system of claim 1, further comprising an internal combustion engine mechanically couplable to said propeller.

12. The solar relay aircraft of claim 1, wherein said internal combustion engine is configured to run on a fuel selected from gasoline, hydrogen, compressed natural gas, diesel fuel, and hydrocarbons.

13. The solar relay aircraft system of claim 1, further comprising a power tower configured to receive solar radiation from said means for directing said solar radiation and generate electricity in response thereto.

14. The solar relay aircraft system of claim 13, wherein said power tower further comprises a cooling system.

15. The solar relay aircraft system of claim 13, wherein said power tower further comprises a power inverter.

16. The solar relay aircraft system of claim 15, wherein said inverter is in electrical connection with a power grid to provide electrical energy thereto.

16. The solar relay aircraft system of claim 1, further comprising a guidance navigation system.

17. A solar relay aircraft system, comprising:
a solar relay aircraft having an upper surface, and a lower surface;
a solar radiation receiver on said lower surface and capable of converting solar energy to electrical energy;
an electric motor mechanically coupled to a propeller and in electrical connection with said solar radiation receiver to receive said electrical energy;
a power tower configured to receive solar radiation and generate electricity in response thereto; and
a means for directing said solar radiation from the sun towards said solar relay aircraft and said power tower.

18. The solar relay aircraft system of claim 17, wherein said solar radiation receiver comprises a plurality of multi-junction solar cells capable of receiving solar radiation having an intensity in excess of one sun.

19. The solar relay aircraft system of claim 18, wherein said solar relay aircraft further comprises an internal combustion engine operable on a fuel selected from gasoline, hydrogen, compressed natural gas, diesel fuel, and hydrocarbons.

20. A method for operating a solar relay aircraft, comprising the steps of:
providing a solar relay aircraft having an upper surface and a lower surface, having a solar radiation receiver on said lower surface and capable of converting solar energy to electrical energy and having an electric motor mechanically coupled to a propeller and in electrical connection with said solar radiation receiver to receive said electrical energy; and
directing solar radiation from the sun towards said solar radiation receiver to provide electrical energy to said solar relay aircraft.

21. The method of claim 20, further comprising providing an internal combustion engine mechanically couplable to said propeller to propel said aircraft.

22. The method of claim 21, further comprising a means for selecting between said electric motor and said internal combustion engine.

23. An unmanned aircraft system, comprising:
at least one solar relay aircraft having a solar collector;
at least one mirror facility configured to direct solar radiation from the sun to said solar collector; and
a means for tracking said solar relay aircraft to maintain said solar radiation on said solar collector.
